(19) United States
(12) Patent Application Publication
(10) Pub. No.: US 2025/0113123 A1
(43) Pub. Date: Apr. 3, 2025

(54) METHOD AND SYSTEM FOR OPTICAL CONTROLS OF ELASTIC PASSBANDS

(71) Applicant: Infinera Corp., San Jose, CA (US)

(72) Inventors: Aryabhata Deshpande, Bommanagalli (IN); Nikhil Kumar Satyarthi, Bangalore (IN); Baranidhar Ramanathan, Karnataka (IN)

(21) Appl. No.: 18/901,252

(22) Filed: Sep. 30, 2024

Related U.S. Application Data
(60) Provisional application No. 63/541,703, filed on Sep. 29, 2023.

(51) Int. Cl. H04Q 11/00; H04J 14/02

(52) U.S. Cl. CPC H04Q 11/0005; H04J 14/0212

(57) ABSTRACT

Networks and network elements having an optical power control block, service and power control orchestrator, used to activate, deactivate and perform optical control of channels is disclosed hereby. The invention introduces the idea that, user created service would be activated or deactivated in smaller increments which would help to mitigate power transient on the transmission line. This approach of incremental activation or deactivation would help to correct against undesirable power changes on rest of the optical channels sharing the common optical path. In addition, it provides a way to monitor the health of increment under activation throughout the activation and if necessary optical power thresholds being not met, it can be rolled back. During the process of such an incremental activation or deactivation, the already activated portion of the channel would continue to be optically controlled independently.

### CROSS-REFERENCE TO RELATED APPLICATION

This application claims priority to U.S. Provisional Patent Application No. 63/541,703, filed Sep. 29, 2024, the entire content of which is incorporated herein by reference in its entirety.

### DESCRIPTION OF THE PRIOR ART

As background, optical networking is a communication means that utilizes signals encoded in light to transmit information, e.g., data, as an optical signal in various types of telecommunications networks. Optical networking may be used in relatively short-range networking applications such as in a local area network (LAN) or in long-range networking applications spanning countries, continents, and oceans. Generally, optical networks utilize optical amplifiers, a light source such as lasers or LEDs, and wavelength division multiplexing to enable high-bandwidth communication.

Optical networks are a critical component of the global Internet backbone. This infrastructure acts as the underlay, providing the plumbing for all other communications to take place (e.g., access, metro, and long-haul). In the traditional 7-layer OSI model, Optical networks constitute the Layer 1 functions, providing digital transmission of bit streams transparently across varying distances over a chosen physical media (in this case, optical). Optical networks also encompass an entire class of devices (which are referred to as Layer 0), which purely deal with optical photonic transmission and wavelength division multiplexing (WDM). This includes amplification, (re-)generation, and optical add/drop multiplexing (OADM). The most widely adopted Layer 1/Layer 0 transport networking technologies today, referred to as Optical Transport Networks (OTN), are based on ITU-T standards. Both of these classes of networks are connection-oriented and circuit-switched in nature.

An optical transport network is comprised of multiple optical network elements including a light source which converts the digital data into optical wavelengths, a light sink which converts the optical wavelengths back into the digital data, a multiplexer (mux) module which multiplexes optical wavelengths from multiple light sources, a demultiplexer (de-mux) module which de-multiplexes optical wavelengths to multiple light sinks and optical amplifiers which amplifies the whole of the C/L/C+L band.

Dense Wavelength Division Multiplexing (DWDM) is an optical transmission technology that uses a single fiber optic link to simultaneously transport multiple optical services of different wavelengths. The different wavelengths are conventionally separated into several frequency bands, each frequency band being used as an independent channel to transport optical services of particular wavelengths. The Conventional Band (C-band) typically includes signals with wavelengths ranging from 1530 nm to 1565 nm, is the frequency band in which optical services experience the lowest amount of loss, and is the band most commonly used in DWDM. The Long-wavelength Band (L-band), which typically includes signals with wavelengths ranging from 1565 nm to 1625 nm, is the frequency band in which optical services experience the second lowest amount of loss, and is the frequency band often used when the C-band is insufficient to meet bandwidth requirements. Optical link systems that use both the C-band and the L-band are referred to as C+L or C/L optical link systems.

Each of the optical network elements i.e. —Wavelength Selective Switches (WSS) and optical amplifiers used in the optical transport network have some target power which needs to be launched on the outgoing optical fiber which is optimal enough so that the receiving equipment on the other end of the optical fiber has the best quality of signal received. The aim of launching with such optimal powers is to have good signal-to-noise-ratio (SNR) values so that the signal quality can be maintained over the longest distance possible in the network and hence achieve cost optimization.

Hence, each of the optical network elements have an associated optical power control loop running which periodically monitors the power levels and automatically adjusts the attenuation levels/gain associated with the optical network element so as to maintain the optimal launched power. The optical amplifiers may contain Variable Optical Amplifiers (VOAs) through which the power levels can be controlled. It may be possible that the amplifier gain itself might be adjustable by the optical power control loop. The optical power control loop associated with an optical amplifier does the targeting at the band level. A Wavelength Selective Switch used in the mux/de-mux module which apart from the multiplexing or demultiplexing the passbands from/to the respective tributary ports also has attenuation control knobs through which its associated optical power control loop can change the power level of the passband. The targeting at mux/de-mux module is on a per passband basis. There may be VOAs used in mux/de-mux modules as well depending on design of the module. Such variable power adjustable components are required to have flexibility of adapting to the changes in the optical characteristics of the network for example—loss in fiber, equipment ageing, optical interference, configuration changes, etc.

C+L optical link systems may be susceptible to experiencing optical power transients during loading operations in which additional frequency bands are enabled within the optical networks due to the Stimulated Raman Scattering (SRS) effect across the different frequency bands. This Stimulated Raman Scattering (SRS) effect can lead to traffic drop on pre-existing services in one frequency band if there is a significant loading change in another frequency band with the optical network.

### SUMMARY OF THE INVENTION

In optical networks, such as C+L-band networks, services in a particular band (i.e., the C-band or the L-band) should be carefully loaded to minimize the effects of optical power changes on pre-existing services. This is due to the SRS effect. an

In one implementation, the problems of mitigating or limiting transients and the SRS effect when loading frequency bands services in a C+L band optical network is solved by a launch protocol operating on at least one processor, and dividing a passband to be loaded into multiple sub-passbands to be loaded separately in a contiguous manner while monitoring power levels within pre-existing services within the optical network.

As will be discussed below, the multiple sub-passbands (e.g., first sub-passband, second sub-passband, etc.) to be loaded can be denoted as secondary sub-passbands. A secondary sub-passband is a temporary logical entity including data, e.g., provisioned or requested data, with parameters indicative of the temporary logical entity. To open a secondary sub-passband, the wavelength selective switch receives a signal specifying a start frequency and an end frequency and instructions to (1) open the secondary sub-passband with a low power level; and to (2) gradually increase the power level of the secondary sub-passband. Once the secondary sub-passband has achieved full power, i.e., become activated within the wavelength selective switch, if a primary sub-passband exists within the passband, the provisioning data of the secondary sub-passband is merged with the provisioning data of the primary sub-passband and the secondary sub-passband may cease to exist within the optical transport network. If the secondary sub-passband is the first secondary sub-passband to be activated within the passband, a candidate primary sub-passband is created in a primary control data store database, and the secondary sub-passband is merged with the candidate primary sub-passband within the primary control data store database to becomes an initial primary sub-passband within the passband. This can be accomplished by saving the provisioning data and/or parameters of the secondary sub-passband in a primary control data store database.

The width between the start frequency and an end frequency of each secondary sub-passband can be selected so as to avoid causing power level changes due to SRS with any pre-existing channels or services within the optical network. To avoid causing power level changes significant enough to cause disruptions due to SRS with the pre-existing channels, the power of the secondary sub-passband is increased gradually while monitoring the power levels of the pre-existing channels and the primary sub-passband until full power of the secondary sub-passband is achieved. If the power levels of the pre-existing channels or the primary sub-passband are changed (increase/decrease) due to the power level within the secondary sub-passband, then the power level of the primary sub-band can be reduced or increased appropriately to maintain it to be at target by changing the attenuation. The secondary sub-passband is contiguous with the primary sub-passband. Once full power of the secondary sub-passband is achieved, the secondary sub-passband is merged to become part of the primary sub-passband. This process is then repeated for at least one additional secondary sub-passband until the entire passband has been activated.

When activating the additional secondary sub-passband(s) for the passband, power levels of the secondary sub-passband and the primary sub-passband can be monitored and adjusted separately. This allows the power levels of the primary sub-passband to be controlled independently of the power levels of the secondary sub-passband and thereby maintain the power level of the primary sub-passband at a desired power level as the power levels of the secondary sub-passband are gradually increased. Adjusting the power levels within the primary sub-passband and the secondary sub-passband can be accomplished by one or more optical attenuators and/or one or more variable optical amplifier in the wavelength selective switch. By activating multiple secondary sub-passbands within the passband separately, and merging the secondary sub-passbands individually with the primary sub-passband the entire passband can be gradually and incrementally activated without causing significant power level changes with the pre-existing channels. During the activation of the secondary sub-passbands, each of the secondary sub-passbands includes data (e.g., provisioned date or requested data) stored in a secondary control data store database. This permits each of the secondary sub-passbands to be a separate entity from the primary sub-passband in the optical transport network. Thus, power controls, provisioning, etc. is performed separately on the secondary sub-passband and the primary sub-passband.

During execution of this launch protocol, one or more carriers within the primary sub-passband can be activated to carry customer data within the optical transport network during a time period in which one or more secondary sub-passbands are being activated.

In one embodiment, the present disclosure describes a network element provided with a processor, a first line port, a wavelength selective switch, a second line port, an optical power monitor, and a memory. The first line port is optically coupled to a first optical fiber link carrying a first optical signal having a first plurality of passbands. The wavelength selective switch is in optical communication with the first line port. The wavelength selective switch is operable to selectively switch the first optical signal into a second optical signal having a second plurality of passbands. The second line port is optically coupled to a second optical fiber link and operable to carry the second optical signal having the second plurality of passbands, the second line port in optical communication with the wavelength selective switch. The optical power monitor is coupled to at least one of the first optical link and the second optical link, and operable to measure optical power within at least one of the first plurality of passbands and the second plurality of passbands. The memory comprises a non-transitory processor-readable medium storing an upstream data adapter application, an optical power controller application, a control data re-allocator application, a monitoring and downstream data distributor application and storing processor-executable instructions that when executed by circuitry cause the circuitry to: store, in a first database, by the upstream data adapter application, a start frequency and an end frequency of a passband to be activated in the second plurality of passbands; create, by the upstream data adapter application, first data indicative of a first sub-passband within the passband and store the first data within a second database; send signals, by the optical power controller application, to the wavelength selective switch to activate the first sub-passband in the second optical link using the first data and updating the first data with first parameters indicative of the activated first sub-passband, the first sub-passband being a primary activated sub-passband; merge the first data into a third database; create, by the upstream data adapter application, second data indicative of a second sub-passband within the passband and store the second data within the second database, the second sub-passband being contiguous with the first sub-passband; enable, by the optical power controller application, the wavelength selective switch to activate the second sub-passband in the second optical link using the second data and updating the second data with second parameters indicative of the activated second sub-passband; merge, by the control data re-allocator application, the second data with the first data in the third database subsequent to the activation of the second sub-passband so as to expand the primary activated sub-passband with the activated second sub-passband; and pass, by the monitoring and downstream data distributor application, at least a portion of the merged first data and the second data to another network element downstream on the second optical link.

Implementations of the above techniques include methods, apparatus, systems, networks, and computer program products. One such computer program product is suitably embodied in a non-transitory machine-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features, and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness. Not every component may be labeled in every drawing. Like reference numerals in the figures may represent and refer to the same or similar element or function. In the drawings:

FIG. 1 is a block diagram of an exemplary implementation of software control blocks for a network element in an optical transport network constructed in accordance with the present disclosure.

FIG. 2 is a block diagram of an exemplary implementation of an upstream data adapter of the network element of FIG. 1 constructed in accordance with the present disclosure.

FIG. 3 is a diagrammatic view of an exemplary implementation of one step in a launch protocol constructed in accordance with the present disclosure to activate a first secondary sub-passband within a passband having a provisioned start frequency and a provisioned end frequency.

FIG. 4. is a diagrammatic view of an exemplary implementation of another step in the launch protocol to activate a second sub-passband within the passband having the provisioned start frequency and the provisioned end frequency in accordance with the present disclosure.

FIG. 5 is a diagrammatic view of an exemplary alternative implementation of one step in a launch protocol constructed in accordance with the present disclosure to activate a first secondary sub-passband within the passband adjacent to the provisioned end frequency.

FIG. 6 is a block diagram of a control data reallocator of the network element of FIG. 1 with the control data reallocator configured to merge second provisioning data with first provisioning data in a primary data store database subsequent to the activation of the second sub-passband so as to expand the primary activated passband with the activated second sub-passband.

FIG. 7 is a diagrammatic view of an implementation of inputs to the control data reallocator and an output in which second provisioning data has been merged with first provisioning data to provide a primary activated passband based on the provisioned start frequency and the provisioned end frequency.

FIG. 8 is a flow chart showing a first portion of a launch protocol constructed in accordance with the present disclosure.

FIG. 9 is a flow chart showing a second portion of the launch protocol constructed in accordance with the present disclosure.

FIG. 10 is a flow chart showing a deactivation protocol constructed in accordance with the present disclosure.

FIG. 11 is a block diagram of an exemplary implementation of an optical transport network having multiple network elements in which the software control blocks can be implemented in accordance with the present disclosure.

FIG. 12 is a diagram of an exemplary implementation of a computer system shown in FIG. 10 and constructed in accordance with the present disclosure.

FIG. 13A is a block diagram of an exemplary implementation of the network element being a reconfigurable optical add/drop multiplexer constructed in accordance with the present disclosure.

FIG. 13B is a diagram of an exemplary implementation of a light source of FIG. 12A constructed in accordance with the present disclosure.

FIG. 13C is a block diagram of an exemplary implementation of a light sink constructed in accordance with the present disclosure.

FIG. 13D is a block diagram of a wavelength-selective switch module shown in FIG. 12A.

FIG. 14 is another block diagram of the transport network shown in FIG. 11.

FIG. 15 is a block diagram illustrating a flow of information around a wavelength selective switch controller domain.

FIG. 16 is a functional model of an exemplary implementation of an optical services and power controls sub-system constructed in accordance with the present disclosure.

### DETAILED DESCRIPTION

The following detailed description of exemplary embodiments refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein are for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment,” “an embodiment,” “some embodiments,” “one implementation,” “some implementations,” “an implementation,” “one example,” “for example,” or “an example” means that a particular element, feature, structure, or characteristic described in connection with the embodiment/implementation/example is included in at least one embodiment/implementation/example and may be used in conjunction with other embodiments/implementations/examples. The appearance of the phrase “in some embodiments” or “one example” or “in some implementations” in various places in the specification does not necessarily all refer to the same embodiment/implementation/example, for example.

Circuitry, as used herein, may be analog and/or digital components referred to herein as “blocks”, or one or more suitably programmed processors (e.g., microprocessors) and associated hardware and software, or hardwired logic. Also, “components” or “blocks” may perform one or more functions. The term “component” or “block” may include hardware, such as a processor (e.g., a microprocessor), a combination of hardware and software, and/or the like. Software may include one or more processor-executable instructions that when executed by one or more components cause the component to perform a specified function. It should be understood that the algorithms described herein may be stored on one or more non-transitory processor readable medium. Exemplary non-transitory processor readable medium may include random access memory, read-only memory, flash memory, and/or the like. Such non-transitory processor readable medium may be electrically based, optically based, and/or the like.

A “passband”, as used herein, is a logical entity representing a wavelength selective switch optical channel and having a provisioned start frequency and a provisioned end frequency within the electromagnetic spectrum. The passband can be deactivated, partially activated with one or more sub-passbands, or completely activated within the wavelength selective switch.

An “optical channel” in a wavelength selective switch is defined by parameters, i.e., a start frequency, an end frequency, tributary port, line port, and attenuation.

A sub-passband, as used herein, refers to a portion of the passband within the electromagnetic spectrum having a start frequency and an end frequency within a start frequency and an end frequency of a passband. Multiple sub-passbands can be within a passband with a precondition being that the sub-passbands are contiguous.

A primary sub-passband is a sub-passband within the electromagnetic spectrum which has been completely activated by the wavelength selective switch and is contiguous with either the start frequency or the end frequency of the passband.

A secondary sub-passband is a sub-passband within the electromagnetic spectrum which is in the process of being activated by the wavelength selective switch independently of any primary sub-passband within the passband.

Software may include one or more processor-readable instruction that when executed by one or more component, e.g., a processor, causes the component to perform a specified function. It should be understood that the algorithms described herein may be stored on one or more non-transitory processor-readable medium, which is also referred to herein as a non-transitory memory. Exemplary non-transitory processor-readable mediums may include random-access memory (RAM), a read-only memory (ROM), a flash memory, and/or a non-volatile memory such as, for example, a CD-ROM, a hard drive, a solid-state drive, a flash drive, a memory card, a DVD-ROM, a Blu-ray Disk, a disk, and an optical drive, combinations thereof, and/or the like. Such non-transitory processor-readable media may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

The generation of laser beams for use as optical data channel signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

As used herein, an “optical communication path” and/or an “optical route” may correspond to an optical path and/or an optical light path. For example, an optical communication path may specify a path along which light is carried between two or more network entities along a fiber optic link, e.g., an optical fiber.

The optical network has one or more band. A band is the complete optical spectrum carried on the optical fiber. Depending on the optical fiber used and the supported spectrum which can be carried over long distances with the current technology, relevant examples of the same are: C-Band/L-Band/Extended-C-Band. As used herein, the C-Band is a band of light having a wavelength between about 1530 nm and about 1565 nm. The L-Band is a band of light having a wavelength between about 1565 nm and about 1625 nm. Because the wavelength of the C-Band is smaller than the wavelength of the L-Band, the wavelength of the C-Band may be described as a short, or a shorter, wavelength relative to the L-Band. Similarly, because the wavelength of the L-Band is larger than the wavelength of the C-Band, the wavelength of the L-Band may be described as a long, or a longer, wavelength relative to the C-Band.

As used herein, a spectral slice (a “slice”) may represent a spectrum of a particular size in a frequency band (e.g., 12.5 gigahertz (“GHz”), 6.25 GHz, 3.125 GHz, etc.). For example, a 4.8 terahertz (“THz”) frequency band may include 384 spectral slices, where each spectral slice may represent 12.5 GHz of the 4.8 THz spectrum. A slice may be the resolution at which the power levels can be measured by the optical power monitoring device. The power level being measured by the optical power monitoring device represents the total optical power carried by the portion of the band represented by that slice.

Spectral loading, or channel loading, is the addition of one or more channel to a specific spectrum of light described by the light's wavelength in an optical signal. When all channels within a specific spectrum are being utilized, the specific spectrum is described as fully loaded. A grouping of two or more channel may be called a channel group. Spectral loading may also be described as the addition of one or more channel group to a specific spectrum of light described by the light's wavelength to be supplied onto the optical fiber as the optical signal.

A WSS (Wavelength Selective Switch) is a component used in optical communications networks to route (switch) optical signals between optical fibers on a per-slice basis. Generally, power level controls can also be done by the WSS by specifying an attenuation level on a passband filter. A wavelength Selective Switch is a programmable device having source and destination fiber ports where the source and destination fiber ports and associated attenuation can be specified for a particular passband with a minimum bandwidth.

A reconfigurable optical add-drop multiplexer (ROADM) node is an all-optical subsystem that enables remote configuration of wavelengths at any ROADM node. A ROADM is software-provisionable so that a network operator can choose whether a wavelength is added, dropped, or passed through the ROADM node. The technologies used within the ROADM node include wavelength blocking, planar lightwave circuit (PLC), and wavelength selective switching—though the WSS has become the dominant technology. A ROADM system is a metro/regional WDM or long-haul DWDM system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element. So, as the directions switched at a ROADM node increase, the ROADM node's cost increases.

An exemplary optical transport network consists of two distinct domains: Layer 0 (“optical domain” or “optical layer”) and Layer 1 (“digital domain”) data planes. Layer 0 is responsible for fixed or reconfigurable optical add/drop multiplexing (R/OADM) and optical amplification (EDFA or Raman) of optical channels and optical channel groups (OCG), typically within the 1530 nm-1565 nm range, known as C-Band. ROADM functions are facilitated via usage of a combination of colorless, directionless, and contentionless (CDC) optical devices, which may include wavelength selective switches (WSS), Multicast switches (MCS). Layer 0 may include the frequency grid (for example, as defined by ITU G.694.1), ROADMs, FOADMs, Amps, Muxes, Line-system and Fiber transmission, and GMPLS Control Plane (with Optical Extensions). Layer 1 functions encompass transporting client signals (e.g., Ethernet, SONET/SDH) in a manner that preserves bit transparency, timing transparency, and delay-transparency. The predominant technology for digital layer data transport in use today is OTN (for example, as defined by ITU G.709). Layer 1 may transport “client layer” traffic. Layer 1 may be a digital layer including multiplexing and grooming. The optical layer may further be divided into either an OTS layer or an OCH layer. The OTS layer refers to the optical transport section of the optical layer, whereas the OCH layer refers to one or more optical channels which are co-routed, e.g., together as multiple channels.

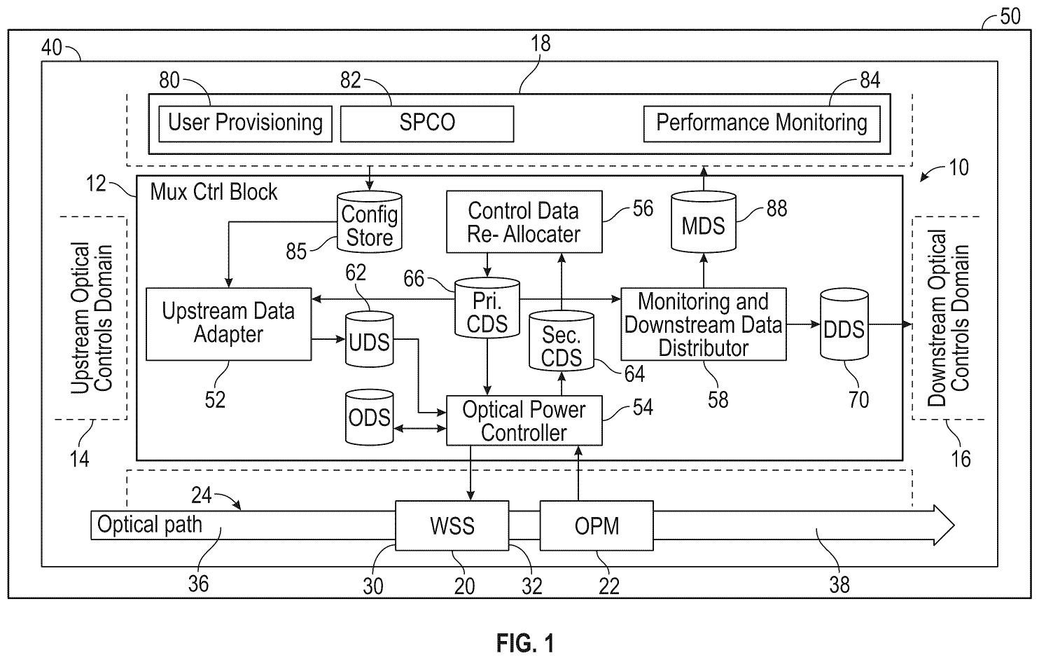

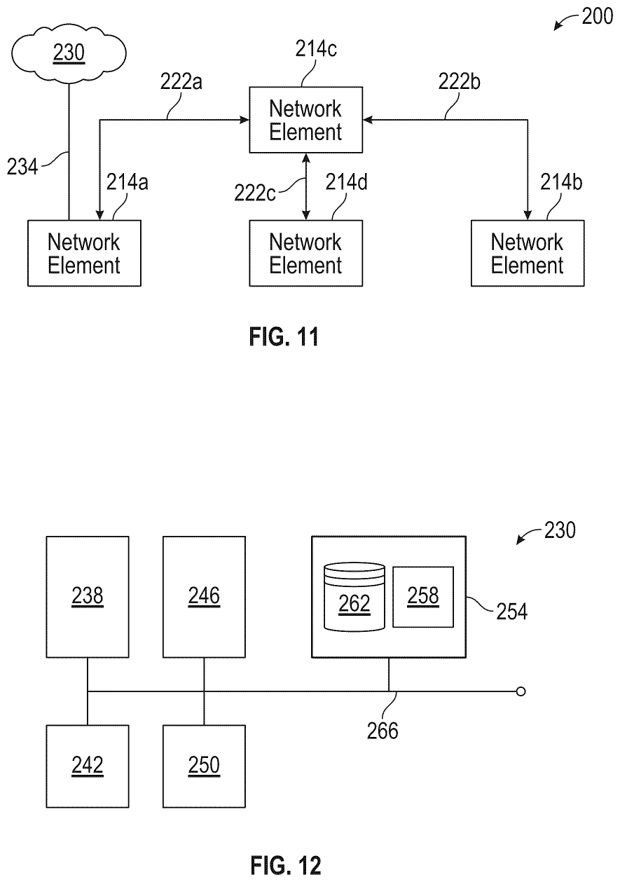

Referring now to the drawings, and in particular to FIG. 1, shown therein is a block diagram of software control blocks 10 for a network element 11 (See FIG. 11) constructed in accordance with the present disclosure. The software control blocks 10 include a multiplexer control block 12, an upstream optical control domain 14, a downstream optical control domain 16, and a user domain 18. The multiplexer control block 12 communicates with a wavelength selective switch 20, and an optical power monitor 22. The wavelength selective switch 20, and the optical power monitor 22 interacts with an optical fiber link 24. The wavelength selective switch 20 is a programmable device having a first line port 30 (e.g., a source line port) and a second line port 32 (e.g., a destination line port) where the first line port 30 and the second line port 32 and associated attenuation can be specified for a particular passband with a minimum bandwidth. The optical power monitor 22 is a device used to measure the power in an optical signal at particular bands in the electromagnetic spectrum. Optical power monitors 22 are known in the art.

The first line port 30 is optically coupled to a first optical link 36 of the optical fiber link 24 and carries a first optical signal having a first plurality of passbands. The second line port 32 is optically coupled to a second optical link 38 and is operable to carry a second optical signal having a second plurality of passbands. The second line port 32 is in optical communication with the wavelength selective switch 20.

The optical power monitor 22 is coupled to at least one of the first optical link 36 and the second optical link 38. In the example shown in FIG. 1, the optical power monitor 22 is coupled to the second optical link 38.

The multiplexer control block 12, the upstream optical controls domain 14, the downstream optical controls domain 16 and the user domain 18 may be implemented as processor-executable instruction stored in a memory 40 (i.e., a non-transitory processor readable medium) that are executable by circuitry 50. The multiplexer control block 12 includes an upstream data adapter application 52, an optical power controller application 54, a control data reallocator application 56, and a monitoring and downstream data distributor application 58. In general, the multiplexer control block 12 stores, user provisioned data and SPCO requested data into a configuration database 85. The multiplexer control block 12 also populates data in a first database (i.e., an upstream data store 62), by the upstream data adapter application, a start frequency and an end frequency of a passband to be activated in the second plurality of passbands; creates, by the upstream data adapter application 52, first data indicative of a first sub-passband within the passband and stores the first data within a second database (i.e., a secondary control data store 64); sends signals, by the optical power controller application 54, to the wavelength selective switch 20 to activate the first sub-passband in the second optical link 38 using the first data; updates the first data with first parameters indicative of the activated first sub-passband, the first sub-passband being a primary activated passband; merges the first data into a third database (i.e., a primary control data store 66); creates, by the upstream data adapter application 52, second data indicative of a second sub-passband within the passband; and stores the second data within the second database (i.e., the secondary control data store 64). The second sub-passband is contiguous with the first sub-passband. The multiplexer control block 12 also enables, by the optical power controller application 54, the wavelength selective switch 20 to activate the second sub-passband in the second optical link 38 using the second data and updates the second data with second parameters indicative of the activated second sub-passband. Then, the control data reallocator application 56 merges the second data with the first data in the third database (i.e., the primary control data store 66) subsequent to the activation of the second sub-passband to create third data so as to expand the primary activated sub-passband with the activated second sub-passband.

Once the primary activated sub-passband has been activated, the monitoring and downstream data distributor application 58 updates a fourth database (i.e., a downstream data store 70) and a fifth database (i.e., a monitoring data store 72). Once the downstream data store 70 is updated, the downstream optical controls domain 16 reads the third data regarding the primary activated sub-passband and passes at least a portion of the third data indicative of the primary activated sub-passband to another network element downstream from the network element on the second optical link 38. As will be discussed in more detail below, the third data indicative of the primary activated sub-passband may include the first data, or the merged first data and the second data. Once the monitoring data store 72 is updated, monitoring parameters like power of the primary passband and active start and end frequency are published to the performance monitoring module 84.

The upstream optical controls domain 14 may be a source control domain that may be located on an upstream network element supplying optical signals into the first optical link 36, such as a source control domain on an add network element or a demux WSS controller domain on an express network element. The skilled artisan is familiar with the terms add network element or a demux WWS controller domain on an express network element. Thus, no further comments regarding these terms is deemed necessary to teach the skilled person how to make and use the element identified by these terms. Similarly, the downstream optical controls domain may be a Mux WSS controller domain on an express network element or a sink control domain on a drop network element. The skilled artisan is familiar with the terms mux WSS controller on an express network element or a sink control domain on a drop network element. Thus no further comments regarding these terms is deemed necessary to teach the skilled person how to make and use the elements identified by these terms.

The user domain 18 may be operable to permit user and/or software configuration of the wavelength selective switch 20. The user domain 18 may also be operable to permit performance monitoring of one or more passband being utilized by the wavelength selective switch 20 to form various services on the first optical link 36 or the second optical link 38. In general, the user domain 18 may be provided with a user provisioning application 80, a service and power control orchestrator 82, and or a performance monitoring application 84. The multiplexer control block 12 includes a configuration store 85 which stores user provisioning start/stop frequencies of the passband and also the service and power control orchestrator (SPCO) 82 requested start and end frequencies to split upstream domain data into the primary and secondary sub-passbands discussed below. User provisioning application 80 is operable to permit user configuration for different services represented by a passband and/or a carrier definition. The service and power control orchestrator 82 identifies one or more passbands which need to be configured in the wavelength selective switch 20 for a particular service. In either case, from the passband and/or carrier definition, the user provisioning application 80 or the service and power control orchestrator 82 identifies one or more passbands which need to be configured in the wavelength selective switch 20 for that particular service. As discussed herein, each passband has a start frequency and an end frequency within the electromagnetic spectrum which may be user-specified using the user provisioning application 80, or software configured using the service and power control orchestrator 82. The performance monitoring application 84 reads data in a monitoring data store 88 and is operable to monitor the performance of one or more passbands being carried by the first optical link 36 and/or the second optical link 38. Because the person of ordinary skill in the art is familiar with how to make and use the user provisioning application 80, and/or the performance monitoring application 84, no further description describing how to make and use the user provisioning application 80, and/or the performance monitoring application 84 is deemed necessary herein. With respect to the service and power control orchestrator 82, details of how to make and use the service and power control orchestrator 82 are incorporated by reference herein.

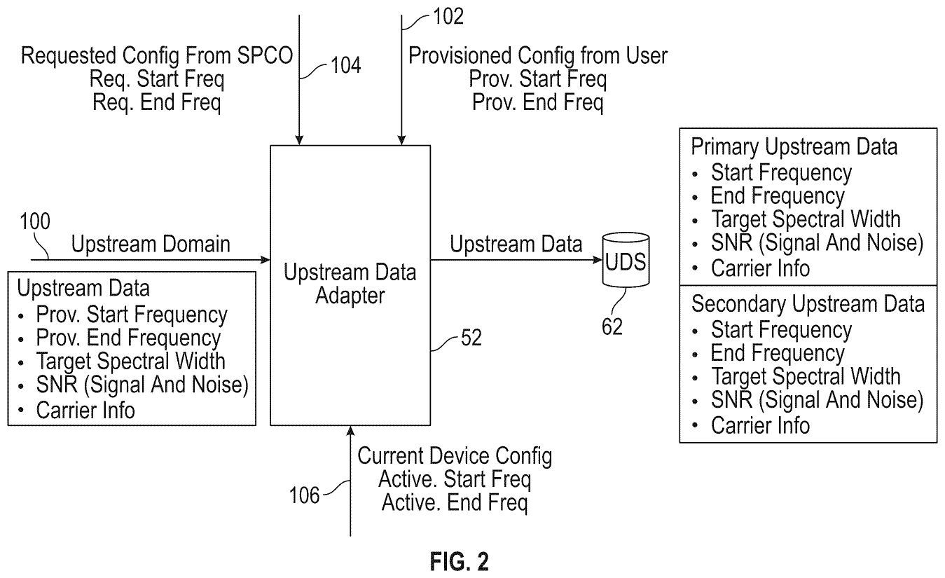

Referring now to FIG. 2, the upstream data adapter application 52 is shown in more detail. In general, the upstream data adapter application 52 is operable to receive and store a start frequency and an end frequency of a passband to be activated in the upstream data store 62. As shown in FIG. 2, the start frequency and the end frequency as well as other data with respect to the passband to be activated can be obtained from a variety of data sources. These data sources include, for example, the upstream optical controls domain 14 as indicated by a communication path 100, the user provisioning application 80 as indicated by a communication path 102, the service and power control orchestrator 82 as indicated by a communication path 104, or a current device configuration stored in the primary control data store 66 as indicated by a communication path 106. The current device configuration includes the activated primary passband start and end frequencies, which may be read from the primary control data store 66.

Exemplary data that can be received from the upstream optical controls domain 14 include the start frequency, the end frequency, a target spectral width, a signal-to-noise ratio, and carrier information, i.e., Carrier start frequency, end frequency, modulation format. Exemplary data that can be received from the user provisioning application may include a provisioned start frequency, and a provisioned end frequency. Exemplary data that can be received from the service and power control orchestrator 82 may include a requested start frequency, and they requested end frequency. The upstream data adapter application 52 stores the data received from the various data sources in the upstream data store 62 after doing necessary distribution of data into primary and secondary passband data.

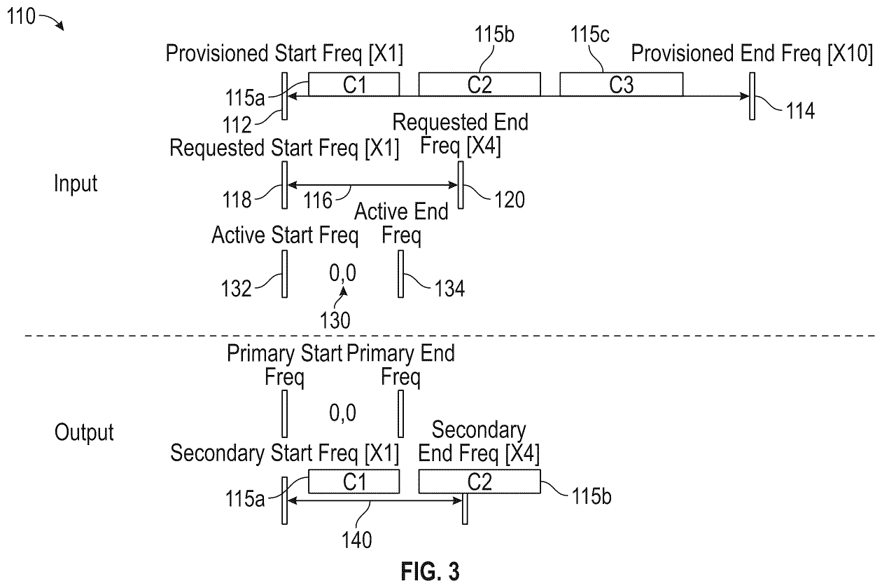

Shown in FIGS. 3-5 are various diagrams showing steps for activating the passbands in accordance with a launch protocol described herein.

Referring now to FIG. 3, shown therein is a provisioned passband 110 having a provisioned start frequency 112, a provisioned end frequency 114 and three carriers 115a, 115b, and 115c to be enabled within the provisioned passband 110. Also shown in FIG. 3 is a first sub-passband 116 having a requested start frequency 118 and a requested end frequency 120; and a candidate primary sub-passband 130 having an active start frequency 132 and an active end frequency 134, which in this case may be the same because the candidate primary sub-passband 130 has not yet been activated. Information with respect to the candidate primary sub-passband 130 may be stored in the primary control data store 66. Provisioning information associated with the first sub-passband 116 having the requested start frequency 118 and the requested end frequency 120 may be stored in the configuration data store 85. Provisioning data with respect to the provisioned passband 110, the first sub-passband 116 and candidate primary sub-passband 130 is passed from the upstream data adapter application 52 to the optical power controller application 54.

The optical power controller application 54 communicates with the wavelength selective switch 20 to activate the first sub-passband 116 in the second optical link 38 based on the provisioning data, for example. The activated first sub-passband 116, which may be discussed herein as a secondary sub-passband is shown in FIG. 3 and denoted by the reference numeral 140. Once the secondary sub-passband is activated, the optical power monitor 22 passes a signal to the control data reallocator application 56 to cause the control data reallocator application 56 to merge the provisioning information with respect to the secondary sub-passband 140 with the candidate primary sub-passband 130 in the primary control data store 66. The control data reallocator application 56 may re-adjust primary passband frequencies as follows: Primary Passband Start Frequency=Min(primary passband start frequency, secondary passband start frequency); Primary Passband End Frequency=Max(Primary Passband End Frequency, Secondary Passband End Frequency). The control data reallocator application 56 may also delete the provisioning information with respect to the secondary sub-passband 140 in the secondary control data store 64 such that the notion of the secondary sub-passband ceases to exist.

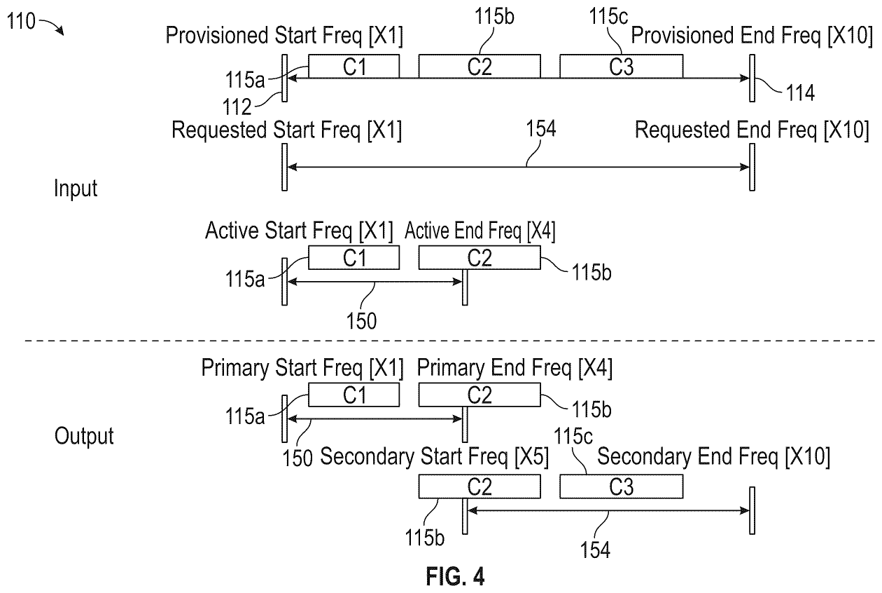

Merging the provisioning information with respect to the secondary sub-passband 140 with the candidate primary sub-passband 130 forms a primary sub-passband 150 in which the carrier 115a can be enabled to carry data traffic. As shown in FIG. 4, the primary sub-passband 150 has an active end frequency that is spectrally partially within the boundaries of the carrier 115b. Because the carrier 115b is not entirely within the primary sub-passband 150, the carrier 115b cannot be enabled at this point in the launch process. In other words, the carrier 115b end frequency is beyond the end frequency of the primary sub-passband 150. The contribution for the carrier 115b contribution to the primary sub-passband 150 spectral width is computed as:

If Carrier Start Freq < Passband Start Freq,
Carr_SW_Start_Freq = Passband Start Frequency
Else
Carr_SW_Start_Freq = Carrier Start Frequency
If Carrier End Frequency > Passband End Frequency
Carr_SW_End_Freq = Passband End Frequency
Else
Carr_SW_End_Freq = Carrier End Frequency

The spectral width contribution of a carrier 115 in the passband 110 or the sub-passbands 116, 150, or 154 can be stated as: Spectral Width=Carr_SW_End_Freq−Carr_SW_Start_Freq. Passband Spectral Width=Sum of Constituent Carrier Spectral Width.

As shown in FIG. 4, the upstream data adapter application 52 creates second provisioning data based on the trigger from SPCO 82 via the configuration data store 85 indicative of a second sub-passband 154 within the passband 110 and stores the second provisioning data within the second database (i.e., the secondary control data store 64). The second sub-passband 154 is contiguous with the primary sub-passband 150. The optical power controller application 54 enables the wavelength selective switch 20 to activate the second sub-passband 154 in the second optical link 38 using the second provisioning data. The optical power controller application 54 monitors the power levels of the primary sub-passband 150, any pre-existing passbands on the second optical link 38 and updating the second provisioning data with second parameters, e.g., attenuation factors, power level, etc. indicative of the activated second sub-passband 154. The optical power controller application 54 after monitoring the power levels of primary passband 150, any other pre-existing passbands on the second optical line 38, if finds a power change, the optical power controller application 54 will control the power levels of the primary passband 150 and other pre-existing passbands by changing the attenuation on the WSS 20 appropriately to maintain desired target powers.

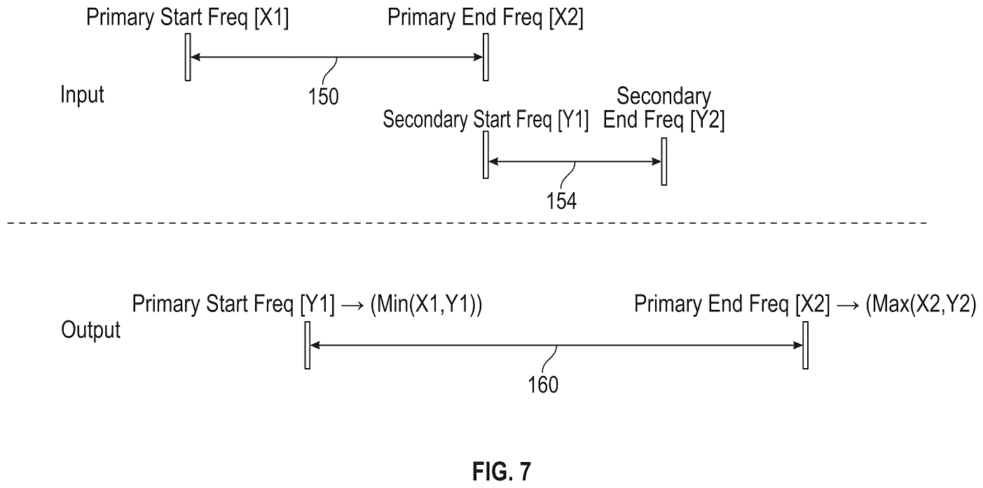

As shown in FIG. 7, Once the primary sub-passband 150 and the second sub-passband 154 (e.g., the secondary sub-passband) are activated, the control data reallocator application 56 merges the second data with the first data in the third database (i.e., the primary control data store 66) subsequent to the activation of the second sub-passband 154 so as to expand the primary sub-passband 150 with the activated second sub-passband 154 to form an activated primary sub-passband 160. Once the primary sub-passband 160 has been activated, the monitoring and downstream data distributor application 58 updates the fourth database (i.e., the downstream data store 70) and the fifth database (i.e., the monitoring data store 72). Once the downstream data store 70 is updated, the downstream optical controls domain 16 reads the data regarding the primary sub-passband 160 and passes at least a portion of data indicative of the primary sub-passband 160 to another network element downstream from the network element on the second optical link 38.

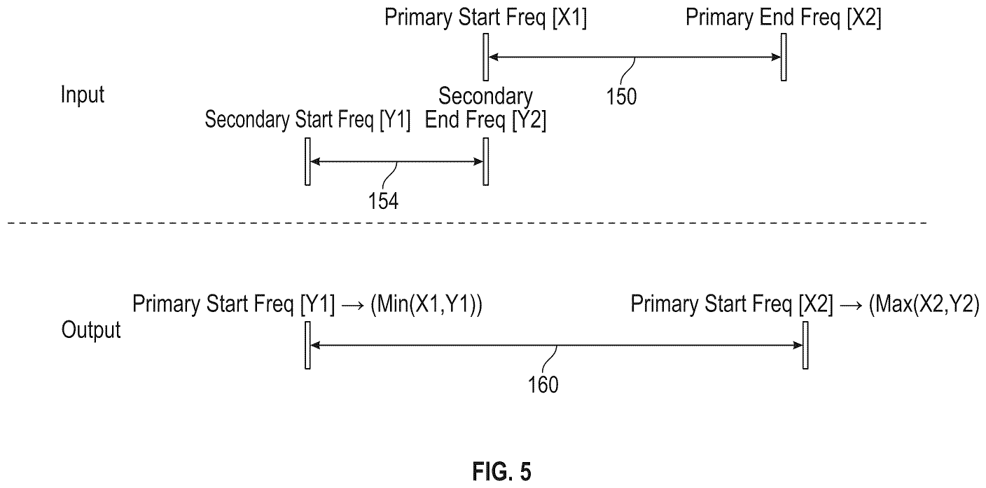

In FIGS. 3 and 4, the launch process is described with the first sub-passband 116 having a requested start frequency being the provisioned start frequency and then activating additional sub-passbands in a left to right fashion. However, as shown in FIG. 5, the requested end frequency of the first sub-passband 116 and resulting primary sub-passband 150 can be the provisioned end frequency. In this case, the launch process would activate additional sub-bands in a right to left fashion.

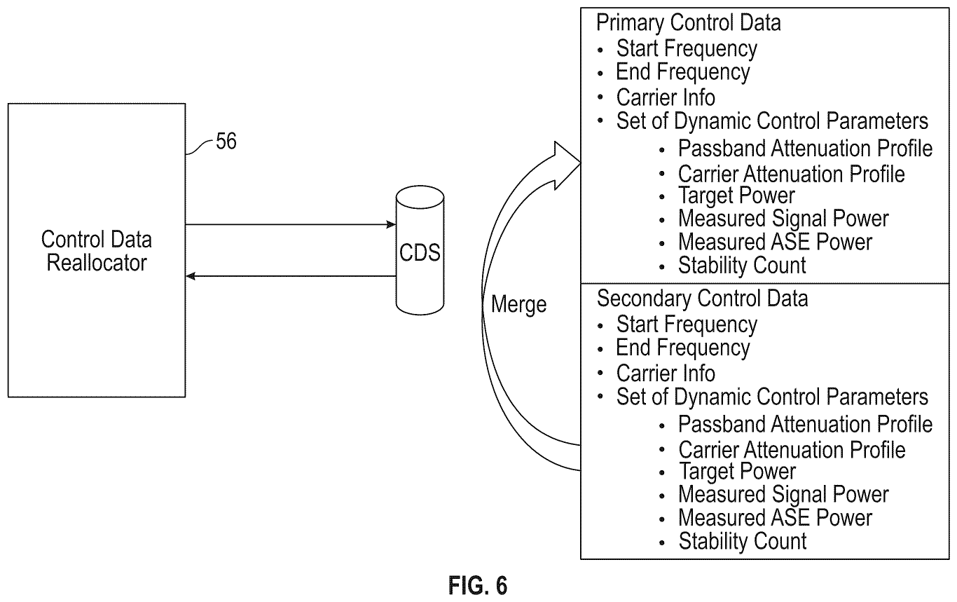

As shown in FIG. 6, the requested data or provisioning data and parameter data of the first sub-passband 116 and/or the second sub-passband 154, for example, may include a start frequency, an end frequency, carrier information, and a set of dynamic control parameters including, but not limited to, passband attenuation profile, carrier attenuation profile, target power, measured signal power, measured ASE (Amplified Spontaneous Emission) power, and a stability count. The control data reallocator application 56 merges the requested data or provisioning data and parameter data of the first sub-passband 116 and/or the second sub-passband 154 stored in the secondary control data store 64 into the primary control data store 66 utilizing suitable database merging operations. Data merging includes re-computation of target spectral width which will be sum of primary passband target spectral width and secondary passband target spectra width. Updated start and end frequency as depicted in FIG. 7. Passband attenuation profile may be stitched from secondary to primary. A stability count may be a logical AND operation of primary and secondary stability counts.

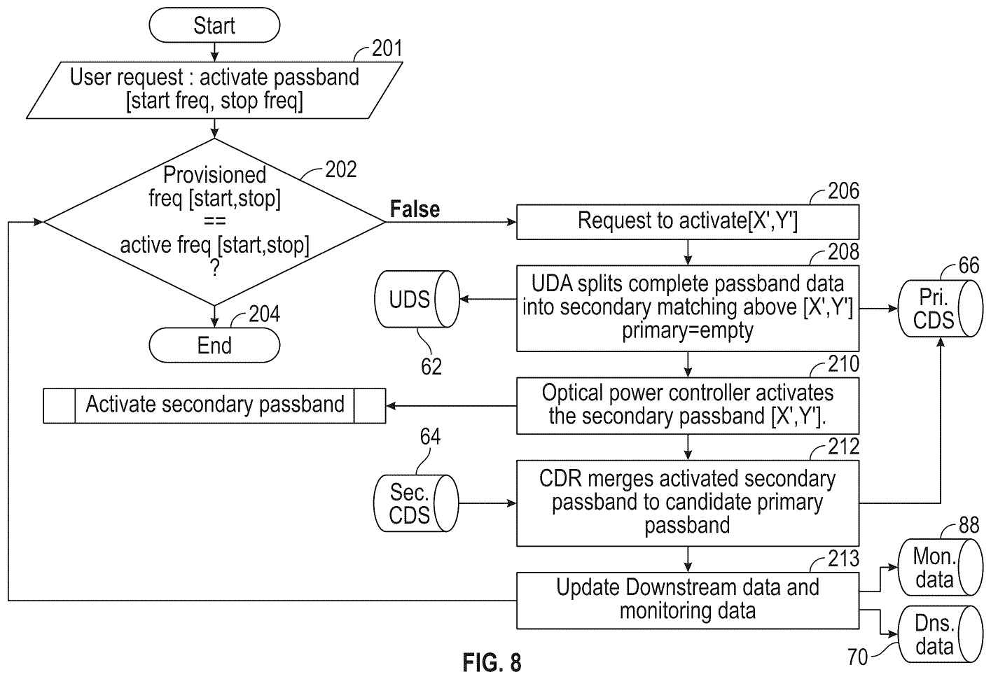

A block diagram of a first portion of an exemplary launch protocol for activating the first sub-passband 116 is shown in FIG. 8, As shown in block 201, a user using the user provisioning application 80 requests to activate the passband 110 and provides the provisioned start frequency 112 and the provisioned end frequency 114. The launch process branches to a decision block 202 to determine whether the passband 110 including the provisioned start frequency 112 and the provisioned end frequency 114 has been entirely activated. If so, the launch process branches to a block 204 and ends the launch process. If not, the launch process branches to a block 206 in which the SPCO 82 generates the subpassband to be loaded by providing requested start and requested end frequency. This comes as a request to activate the passband 110. The launch process then branches to a block 208 in which the upstream data adapter application 52 loads the complete passband data from the upstream data domain 14 and splits the complete passband data into the first sub-passband 116. The upstream data adapter application 52 uses the candidate primary sub-passband 130 active frequency data which is currently 0,0 stored in datastore 66 to deduce the current subpassband as first subpassband. The launch process then branches to a block 210 where the optical power controller application 54 activates the first sub-passband 116 by providing instructions to the wavelength selective switch 20 while monitoring the power of the first sub-passband 116 and pre-existing services on the first optical link 36 and/or the second optical link 38, and updating the secondary control data store 64 with dynamic parameters involved in activating the first sub-passband 116. Once the first sub-passband 116 is activated, the launch process branches to a block 212 in which the control data reallocator application 56 merges the provisioning data and the parameters from the secondary control data store 64 with the information regarding the candidate primary sub-passband 130 in the primary control data store 66. Then, the launch process branches to a block 213 in which the monitoring and downstream data distributor application updates the downstream data store 70 and the monitoring data store 88 thereby signaling downstream network entities regarding the activation of the primary sub-passband 160. The launch process then branches to the block 202 to determine whether any additional sub-passbands should be activated within the passband 110. If not, the launch process branches to the block 204 and ends.

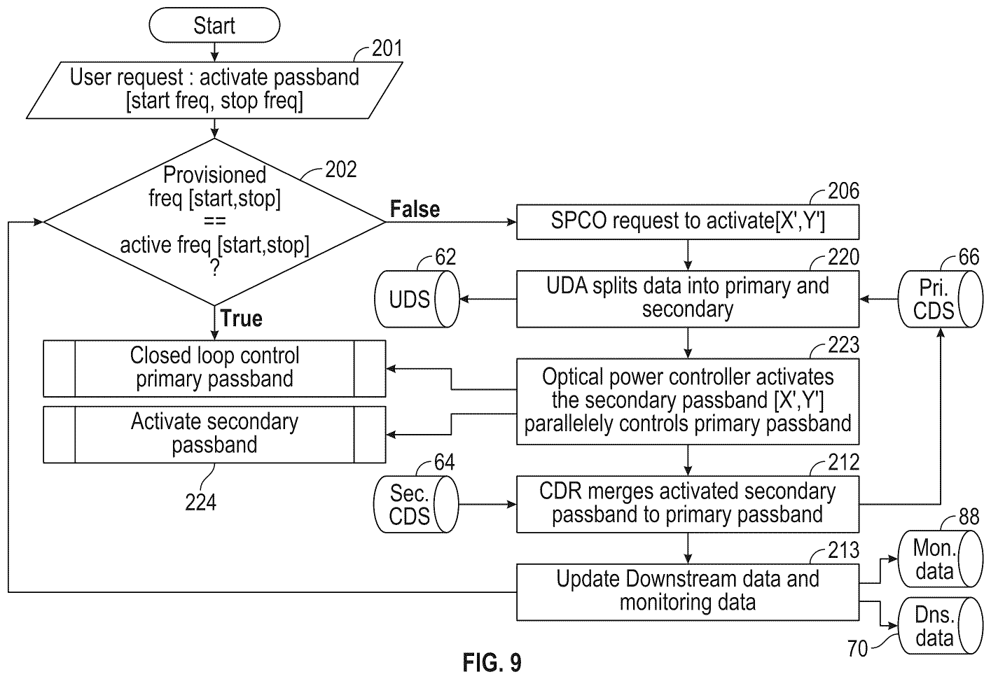

If, however, the entire passband 110 has not been activated, and additional sub-passbands should be activated, then the launch process continues to activate secondary sub-passbands to be merged with the primary sub-passband as shown in FIG. 9.

As shown in FIG. 9, the launch process branches to the block 206 in which the supervisory power and control orchestrator 82 requests the upstream data adapter application 52 to activate the passband 110. The launch process then branches to a block 220 in which the upstream data adapter application 52 loads the complete passband data from the upstream domain 14 and splits the complete passband data into the primary sub-passband 150, and the second sub-passband 154 and stores information regarding the second sub-passband 154 in the upstream data store 62. The launch process then branches to a block 223 where the optical power controller application 54 provides instructions to the wavelength selective switch 20 to activate the second sub-passband 154 to required target as shown by block 224, and to conduct closed loop controls on the primary sub-passband 150, i.e., monitoring the primary sub-passband 150 with the optical power monitor 22. If there is any power drop or increase in the power level within the primary sub-passband 150, the optical power controller application 54 provides instructions to the wavelength selective switch 20 to apply wavelength selective switch attenuation so that the optical power level within the primary sub-passband 150 is at target. activates the first sub-passband 116 by providing instructions to the wavelength selective switch 20 while monitoring the power of the first sub-passband 116 and pre-existing services on the first optical link 36 and/or the second optical link 38 with the optical power monitor 22, and updating the secondary control data store 64 with dynamic parameters involved in activating the first sub-passband 116. Once the first sub-passband 116 is activated, the launch process branches to a block 212 in which the control data reallocator application 56 merges the provisioning data and the parameters from the secondary control data store 64 with the information regarding the candidate primary sub-passband 130 in the primary control data store 66. Then, the launch process branches to a block 213 in which the monitoring and downstream data distributor application updates the downstream data store 70 and the monitoring data store 88 thereby signaling downstream network entities regarding the activation of the primary sub-passband 160. The launch process then branches to the block 202 to determine whether any additional sub-passbands should be activated within the passband 110. If not, the launch process branches to the block 204 and ends.

In some embodiments, the optical power controller application 54 monitors power of the primary sub-passband 150 in the second optical link 38 with the optical power monitor 22 during the step of enabling activation of the second sub-passband 154 in the second optical link 38; enables the wavelength selective switch 20 to activate the second sub-passband 154 in the second optical link 38 using the second provisioning data and the power of the second sub-band 154 in the second optical link 38; enables the wavelength selective switch 20 to maintain the power level of the primary sub-passband 150 at a target power in the second optical link 38 during enabling the wavelength selective switch 20 to activate the second sub-passband 154 in the second optical link; and enables the wavelength selective switch 20 to adjust power in the second sub-passband 154 in the second optical link 38 responsive to receiving a signal from the optical power monitor 22 indicating a change or increase in the power in the primary sub-passband 150 above a predetermined threshold.

Once the primary sub-passband 150 has been activated, the launch process may also activate a carrier 115 within the primary sub-passband 150 to carry data. As shown in FIG. 4, the launch process may activate the carrier 115 spectrally spanning at least a portion of the first sub-passband 116 and the second sub-passband 154 subsequent to activation of the second sub-passband 154. In this embodiment, the launch process may also signal a downstream network element to activate a carrier 115 spectrally spanning at least a portion of the first sub-passband 116 and the second sub-passband 154 subsequent to activation of the second sub-passband 154.

As discussed above, a secondary sub-passband 116 or 154 is a temporary logical entity including provisioning data with parameters indicative of the temporary logical entity. To open a secondary sub-passband 116 or 154, the wavelength selective switch 20 receives a signal specifying a start frequency and end frequency and instructions to (1) open the secondary sub-passband 116 or 154 (e.g., first sub-passband 116 or second sub-passband 154) with a low power level; and to (2) gradually increase the power level of the secondary sub-passband 116 or 154. The skilled artisan will understand that the term “gradually” refers to making multiple changes over time in small amounts. For example, the power level can be increased in 2 dB steps once a second until the power level of the secondary sub-passband 116 or 154 is within 2-3 dB of the target power level. Then, the power level can be increased by 0.2 dB once per second until the target power is achieved. The skilled artisan will understand that other time periods and power level changes can be used to gradually increase the power level of the secondary sub-passband 116 or 154. Once the secondary sub-passband 116 or 154 has achieved a target power, i.e., become activated within the wavelength selective switch 20, if a primary sub-passband 150 exists within the passband 110, the provisioning data of the secondary sub-passband 116 or 154 is merged with the provisioning data of the candidate primary sub-passband 130 or the primary sub-passband 150 and the secondary sub-passband 116 or 154 may cease to exist within the software(processer) and optically the secondary sub-passband 116 or 154 is part of the primary sub-passband in the downstream network. If the secondary sub-passband 116 is the first secondary sub-passband to be activated within the passband 110, the candidate primary sub-passband 130 is created in the primary control data store 66, and the secondary sub-passband 116 is merged with the candidate primary sub-passband 130 within the primary control data store 66 to become an initial primary sub-passband 150 within the passband 110. This can be accomplished by saving the provisioning data and/or parameters of the secondary sub-passband in the primary control data store 66.

The width between the start frequency and an end frequency of each secondary sub-passband 116 or 154 can be selected so as to avoid causing power level changes due to SRS with any pre-existing channels or services within the optical transport network 200. To avoid causing power level changes significant enough to cause disruptions due to SRS with the pre-existing channels, the power of the secondary sub-passband 116 or 154 is increased gradually while monitoring the power levels of the pre-existing channels and/or the primary sub-passband 150 if the primary sub-passband 150 has been created until target power of the secondary sub-passband 116 or 154 is achieved. If the power levels of the pre-existing channels or the primary sub-passband 150 are reducing due to the power level within the secondary sub-passband 116 or 154, for example, then the power level of the primary passband 11xx or 150 can be adjusted and/or maintained until the power levels reach the required target. The secondary sub-passband 154 is contiguous with the primary sub-passband 150. Once target power of the secondary sub-passband 154 is achieved, the secondary sub-passband 116 is merged to become the primary sub-passband 150. This process is then repeated for at least one additional secondary sub-passband 154 until the entire passband 110 has been activated.

When activating the additional secondary sub-passband(s) 154 for the passband 110, power levels of the secondary sub-passband 154 and the primary sub-passband 150 can be monitored and adjusted separately. This allows the power levels of the primary sub-passband 150 to be controlled independently of the power levels of the secondary sub-passband 154 and thereby maintain the power level of the primary sub-passband at a desired power level as the power levels of the secondary sub-passband 154 are gradually increased. Adjusting the power levels within the primary sub-passband 150 and the secondary sub-passband 154 can be accomplished by one or more optical attenuators and/or one or more variable optical amplifier in the wavelength selective switch 20. By activating multiple secondary sub-passbands 154 within the passband 110 separately, and merging the secondary sub-passbands 154 individually with the primary sub-passband 150, the entire passband can be gradually and incrementally activated without causing significant power level changes with the pre-existing services. During the activation of the secondary sub-passbands 154, each of the secondary sub-passbands 154 includes provisioning data stored in a secondary control data store 64. This permits each of the secondary sub-passbands 154 to be a separate entity from the primary sub-passband 150 in the optical transport network 200. Thus, power controls, provisioning, etc. is performed separately on the secondary sub-passband 154 and the primary sub-passband 150.

During execution of this launch protocol, one or more carriers 115a, 115b, or 115c within the primary sub-passband 150 can be activated to carry customer data within the optical transport network 200 during a time period in which one or more secondary sub-passbands 154 are being activated. For each carrier 115, the launch process adds the carrier 115 to the primary sub-passband 150 if the following conditions is met: (1) carrier start frequency>=primary passband start frequency and carrier start frequency<=primary passband end frequency; (2) carrier end frequency>=primary passband start frequency and carrier end frequency<=primary passband end frequency. With respect to a secondary sub-passband 154, one or more carriers 115a, 115b, or 115c may be added to the secondary sub-passband 154 prior to merging the secondary sub-passband 154 into the primary sub-passband 150 if the following conditions are met: (1) carrier start frequency>=secondar passband start frequency and carrier start frequency<=secondary passband end frequency; (2) carrier end frequency>=secondary passband start frequency and carrier end frequency<=secondary passband end frequency. It is possible to have a carrier 115 in both the primary sub-passband 150 and the secondary sub-passband 154 when requested frequency from configuration splits through the carrier.

In some embodiments, the launch protocol may conduct a proactive check of one or more active carriers within the secondary sub-passband 154, to determine whether the secondary sub-passband 154 should be activated or closed. When the secondary sub-passband 154 is created, during activation, i.e., in every intermediate step of activation, overall health of secondary sub-passband 154 may be identified and if the secondary sub-passband 154 is found to not be operating properly, or to not meeting target power levels, or the carrier 115 missing, the secondary sub-passband 154 activation is failed, and its corresponding spectrum (i.e., slices) within the wavelength selective switch 20 are deleted. This way only the secondary sub-passband 154 is monitored and activated or deleted. The primary sub-passband 150 remains in an active state, and won't be affected when an inoperable secondary sub-passband 154 was attempted for activation and failed. Thus, further closed loop control by the optical power controller application 54 can be accomplished on a single entity, i.e., the primary sub-passband 150 even though the secondary sub-passband 154 within the passband 110 failed.

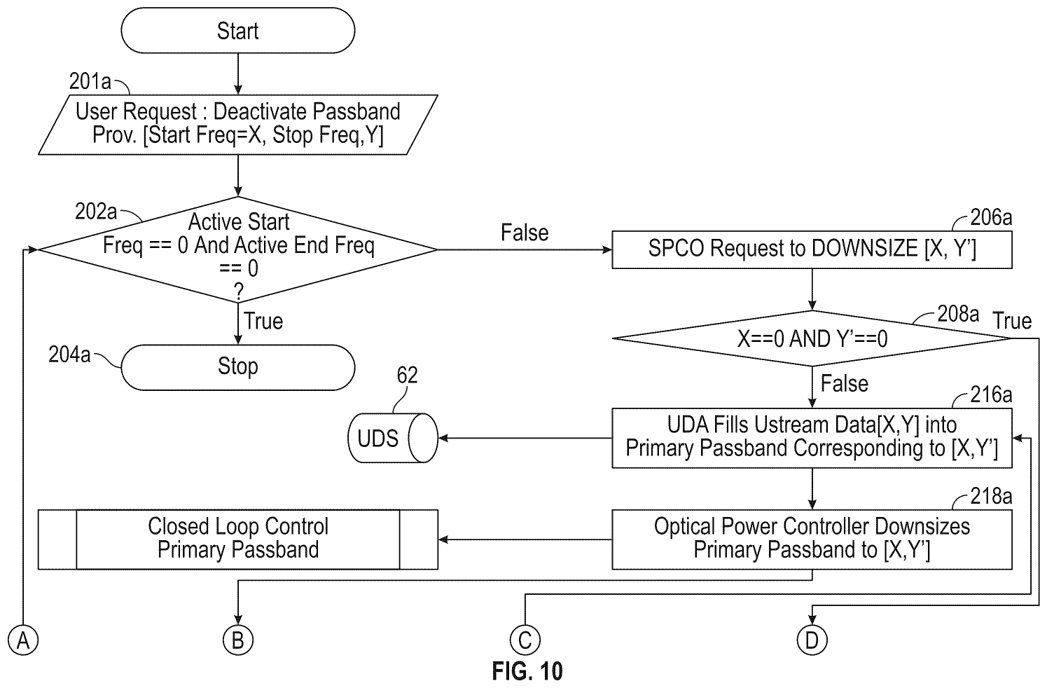

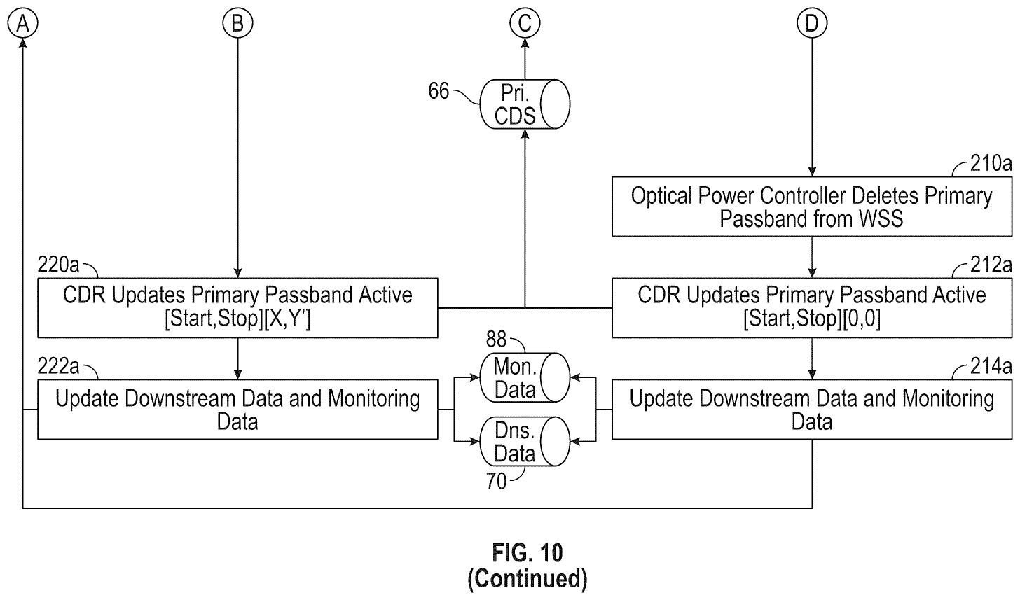

FIG. 10 is a flow chart showing a deactivation protocol constructed in accordance with the present disclosure. The deactivation protocol permits slices of the primary sub-passband 150 or the passband 160 to be deactivated as discussed below. The deactivation process branches to a step 201a in which a user requests deactivation of at least a portion of the primary sub-passband 150 or the passband 160. In this regard, the user provides a start frequency X and a stop frequency Y of at least a portion of the primary sub-passband 150 or the passband 160 to be deactivated. The deactivation protocol branches to decision block 202a where it is determined whether the active start frequency=0 and the active end frequency=0 if so, the requested passband has already been deactivated and so the deactivation protocol branches to step 204a and ends. If not, the deactivation process branches to a block 206a in which the supervisory power and control orchestrator 82 requests the upstream data adapter application 52 to downsize [X,Y] in the primary sub-passband 150 or the passband 160. The upstream data adapter application 52 determines whether the sub-passband has to be deactivated at a decision step 208a.

If so, the deactivation process deletes the channel in the wavelength selective switch 20 by sequentially branching to steps 210a, 212a and 214a. At step 210a, the optical power controller 54 deletes at least a portion of the primary sub-passband 150 or the passband 160 from the wavelength selective switch 20. Then, the control data reallocator 56 updates primary passband Active [Start, Stop Frequencies] to [0,0] in the primary control data store 66 to indicate that the deactivated passband is no longer active. Then, the deactivation process branches to a block 214a in which the monitoring and downstream data distributor application 58 updates the downstream data store 70 and the monitoring data store 88 thereby signaling downstream network entities regarding the deactivation of at least a portion of the primary sub-passband 150, or the passband 160.

If the sub-passband has not been deactivated, the deactivation process branches to a step 216a where the upstream data adapter application 52 provides data into the upstream data store 62 indicative of the start frequency and the end frequency to be downsized to. The deactivation process then branches to step 218a where the optical power controller 54 downsizes the primary sub-passband 150 or the passband 160 to the requested start frequency and the end frequency. The optical power controller 54 enables the wavelength selective switch to downsize the passband 160, for example, from carrying data by gradually reducing power levels within the first sub-passband. The first sub-passband is contiguous with the start frequency or the end frequency of the passband to be deactivated. After the first sub-passband has been deactivated, the optical power controller 54 also enables the wavelength selective switch 20 to run power monitoring on the retained portion of the passband. i.e new downsized primary passband.

During the step 218a, the optical power controller 54 directs the closed loop controls on the primary sub-passband 150 or the passband 160 to monitor power levels of any parts of the primary sub-passband 150 or the passband 160 or other services that are not being deactivated to make changes in the wavelength selective switch 20 to maintain the target power in these parts. Thus, deactivating a portion of or the entire primary sub-passband 150 or the passband 160 in sub-passband increments should not detrimentally affect the power levels of these services that are not being deactivated.

Once the primary sub-passband 150 or the passband 160 has been downsized by the requested start frequency and the end frequency, the control data reallocator 56 updates primary passband Active [Start, Stop Frequencies][X,Y′] in the primary control data store 66 to indicate that the deactivated passband is no longer active at a block 220a. Then, the deactivation process branches to a block 222a in which the monitoring and downstream data distributor application 58 updates the downstream data store 70 and the monitoring data store 88 thereby signaling downstream network entities regarding the deactivation of at least a portion of the primary sub-passband 150, or the passband 160. Further it branches to block 202a where if evaluation returns true same procedure is continued, till last portion of passband is deleted from WSS.

By activating and deactivating certain passbands and/or sub-passbands within the wavelength selective switch 20, the present disclosure supports resizable services without traffic disruption. This supports a pay as you grow client business model that assists the client in matching services provided to the client in the optical transport network 200 to the client's needs. The launch process and the deactivation process described above can also be used to expand the passband 160 by adding or subtracting contiguous passbands to the passband 160.

Referring now to FIG. 11, shown therein is a diagram of an exemplary implementation of the optical transport network 200 constructed in accordance with the present disclosure incorporating the software control blocks 10. The optical transport network 200 is depicted as having a plurality of network elements 214a-n, including a first network element 214a, a second network element 214b, a third network element 214c, and a fourth network element 214d. Though four network elements 214 are shown for exemplary purposes, it will be understood that the plurality of network elements 214a-n may comprise more or fewer network elements 214. Data transmitted within the optical transport network 200 from the first network element 214a to the second network element 214b may travel along an optical path formed from a first fiber optical link 222a, the third network element 214c, and, a second fiber optical link 222b to the second network element 214b.

In one embodiment, a user may interact with a computer system 230, e.g., via a user device, that may be used to communicate with one or more of the network elements 214a-n (hereinafter “network element 214”) via a communication network 234.

In some implementations, the computer system 230 (described below in reference to FIG. 12 in more detail) may comprise a processor and a memory having a data store that may store data such as network element version information, firmware version information, sensor data, system data, metrics, logs, tracing, and the like in a raw format as well as transformed data that may be used for tasks such as reporting, visualization, analytics etc. The data store may include structured data from relational databases, semi-structured data, unstructured data, time-series data, and binary data. The data store may be a data base, a remote accessible storage, or a distributed filesystem. In some embodiments, the data store may be a component of an enterprise network.

In some implementations, the computer system 230 is connected to one or more network element 214 via the communication network 234 and executes the user domain 18 described above. In this way, the computer system 230 may communicate with each of the one or more network element 214, and may, via the communication network 234 transmit or receive data from each of the one or more network element 214 for purposes of provisioning the passband 110 and/or performance monitoring of the passband 110. In other embodiments, the computer system 230 may be integrated into each network element 214 and/or may communicate with one or more pluggable card within the network element 214. In some embodiments, the computer system 230 may be a remote network element.

The communication network 234 may permit bi-directional communication of information and/or data between the computer system 230 and/or the network elements 214 of the optical transport network 200. The communication network 234 may interface with the computer system 230 and/or the network elements 214 in a variety of ways. For example, in some embodiments, the communication network 234 may interface by optical and/or electronic interfaces, and/or may use a plurality of network topographies and/or protocols including, but not limited to, Ethernet, TCP/IP, circuit switched path, combinations thereof, and/or the like. The communication network 234 may utilize a variety of network protocols to permit bi-directional interface and/or communication of data and/or information between the computer system 230 and/or the network elements 214.

The communication network 234 may be almost any type of network. For example, in some embodiments, the communication network 234 may be a version of an Internet network (e.g., exist in a TCP/IP-based network). In one embodiment, the communication network 234 is the Internet. It should be noted, however, that the communication network 234 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 234 is the Internet, a primary user interface of the computer system 230 may be delivered through a series of web pages or private internal web pages of a company or corporation, which may be written in hypertext markup language, JavaScript, or the like, and accessible by the user. It should be noted that the primary user interface of the computer system 230 may be another type of interface including, but not limited to, a Windows-based application, a tablet-based application, a mobile web interface, a VR-based application, an application running on a mobile device, and/or the like. In one embodiment, the communication network 234 may be connected to one or more of the user devices, computer system 230, and the network elements 214a-n.

The optical transport network 200 may be, for example, considered as a graph made up of interconnected individual nodes (that is, the network elements 214). The optical transport network 200 may include any type of network that uses light as a transmission medium. For example, the optical transport network 200 may include a fiber-optic based network, an optical transport network, a light-emitting diode network, a laser diode network, an infrared network, a wireless optical network, a wireless network, combinations thereof, and/or other types of optical networks.

The number of devices and/or networks illustrated in FIG. 11 is provided for explanatory purposes. In practice, there may be additional devices and/or networks, fewer devices and/or networks, different devices and/or networks, or differently arranged devices and/or networks than are shown in FIG. 11. Furthermore, two or more of the devices illustrated in FIG. 11 may be implemented within a single device, or a single device illustrated in FIG. 11 may be implemented as multiple, distributed devices. Additionally, or alternatively, one or more of the devices of the optical transport network 200 may perform one or more functions described as being performed by another one or more of the devices of the optical transport network 200. Devices of the computer system 230 may interconnect via wired connections, wireless connections, or a combination thereof. For example, in one embodiment, the user device and the computer system 230 may be integrated into the same device, that is, the user device may perform functions and/or processes described as being performed by the computer system 230, described below in more detail.

Referring now to FIG. 12, shown therein is a diagram of an exemplary embodiment of the computer system 230 constructed in accordance with the present disclosure. In some embodiments, the computer system 230 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the computer system 230 may include one or more input devices 238 (hereinafter “input device 38”), one or more output devices 242 (hereinafter “output device 242”), one or more processors 246 (hereinafter “processor 246”), one or more communication devices 250 (hereinafter “communication device 250”) capable of interfacing with the communication network 234, one or more non-transitory processor-readable medium (hereinafter “computer system memory 254”) storing processor-executable code and/or software application(s) 258, a database 262, for example including, a web browser capable of accessing a website and/or communicating information and/or data over a wireless or wired network (e.g., the communication network 234), and/or the like. The input device 238, the output device 242, the processor 246, the communication device 250, and the computer system memory 254 may be connected via a path 266 such as a data bus that permits communication among the components of the computer system 230.

In some implementations, the processor 246 may comprise one or more processor 246 working together, or independently, to read and/or execute processor executable code and/or data, such as stored in the computer system memory 254. The processor 246 may be capable of creating, manipulating, retrieving, altering, and/or storing data structures into the computer system memory 254. Each element of the computer system 230 may be partially or completely network-based or cloud-based, and may or may not be located in a single physical location.

Exemplary implementations of the processor 246 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 246 may be capable of communicating with the computer system memory 254 via the path 266 (e.g., data bus). The processor 246 may be capable of communicating with the input device 238 and/or the output device 242.

The processor 246 may be further capable of interfacing and/or communicating with the network elements 214 via the communication network 234 using the communication device 250. For example, the processor 246 may be capable of communicating via the communication network 234 by exchanging signals (e.g., analog, digital, optical, and/or the like) via one or more ports (e.g., physical or virtual ports) using a network protocol to provide information to the one or more network element 214.

The computer system memory 254 may store a software application 258 that, when executed by the processor 246, causes the computer system 230 to perform an action such as communicate with, or control, one or more component of the computer system 230, the optical transport network 200 (e.g., the one or more network element 214a-n) and/or the communication network 234. The data distributor application 58 may be the user domain 18 discussed above.

In some implementations, the computer system memory 254 may be located in the same physical location as the computer system 230, and/or one or more computer system memory 254 may be located remotely from the computer system 230. For example, the computer system memory 254 may be located remotely from the computer system 230 and communicate with the processor 246 via the communication network 234. Additionally, when more than one computer system memory 254 is used, a first computer system memory may be located in the same physical location as the processor 246, and additional computer system memory may be located in a location physically remote from the processor 246. Additionally, the computer system memory 254 may be implemented as a “cloud” non-transitory processor-readable storage memory (i.e., one or more of the computer system memory 254 may be partially or completely based on or accessed using the communication network 234).

In one implementation, the database 262 may be a time-series database, a relational database or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 262 can be centralized or distributed across multiple systems.

The input device 238 may be capable of receiving information input from the user, another computer, and/or the processor 246, and transmitting such information to other components of the computer system 230 and/or the communication network 234. The input device 238 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 242 may be capable of outputting information in a form perceivable by the user, another computer system, and/or the processor 246. For example, implementations of the output device 242 may include, but are not limited to, a computer monitor, a screen, a touchscreen, a speaker, a website, a television set, a smart phone, a PDA, a cell phone, a fax machine, a printer, a laptop computer, a haptic feedback generator, a network interface, combinations thereof, and the like, for example. It is to be understood that in some exemplary embodiments, the input device 238 and the output device 242 may be implemented as a single device, such as, for example, a touchscreen of a computer, a tablet, or a smartphone. It is to be further understood that as used herein the term “user” is not limited to a human being, and may comprise a computer, a server, a website, a processor, a network interface, a user terminal, a virtual computer, combinations thereof, and/or the like, for example.

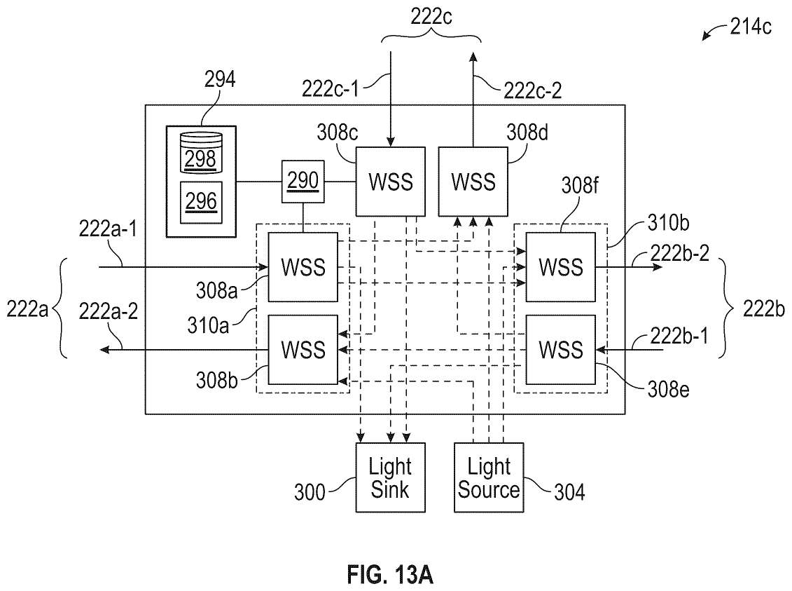

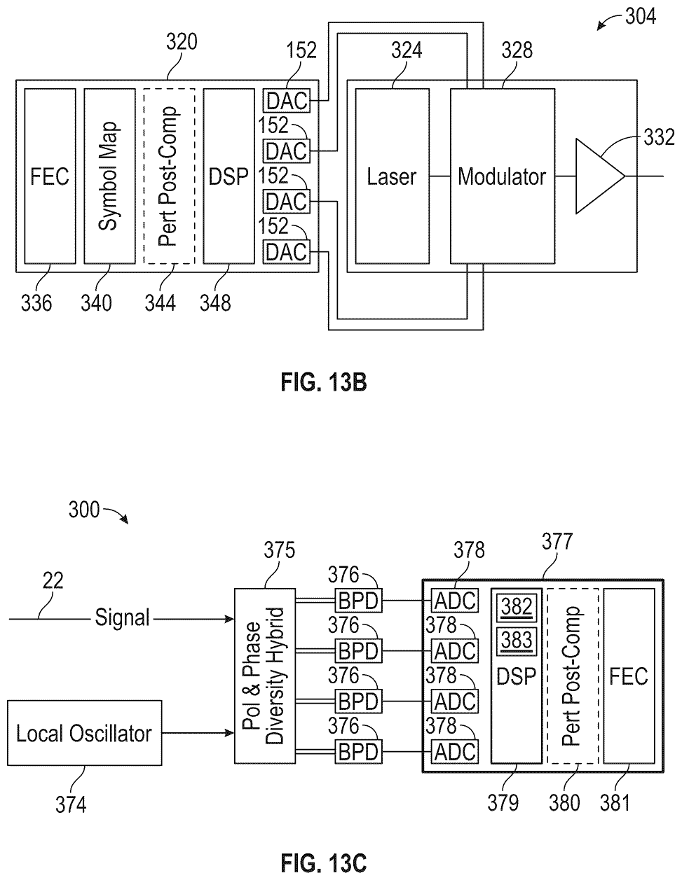

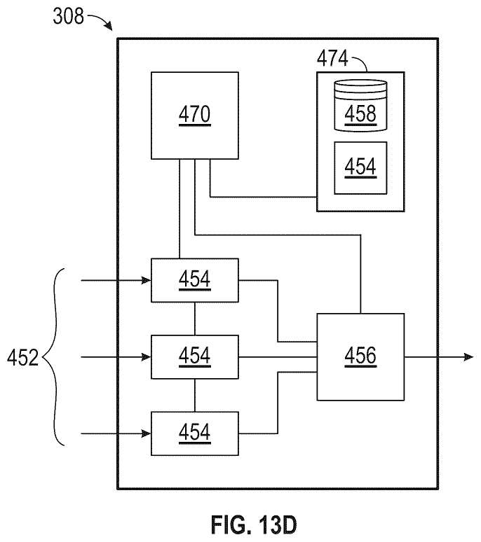

Referring now to FIG. 13A, shown therein is a block diagram of an exemplary implementation of the network element 214 constructed in accordance with the present disclosure. In general, the network element 214 transmits and receives data traffic and control signals.

Nonexclusive examples of alternative implementations of the network element 214 include optical line terminals (OLTs), optical cross connects (OXCs), optical line amplifiers, optical add/drop multiplexer (OADMs) and/or reconfigurable optical add/drop multiplexers (ROADMs), interconnected by way of optical fiber links. OLTs may be used at either end of a connection or optical fiber link. OADM/ROADMs may be used to add, terminate and/or reroute wavelengths or fractions of wavelengths. Optical nodes are further described in U.S. Pat. No. 7,995,921 titled “Banded Semiconductor Optical Amplifiers and Waveblockers”, U.S. Pat. No. 7,394,953 titled “Configurable Integrated Optical Combiners and Decombiners”, and U.S. Pat. No. 8,223,803 (Application Publication Number 20090245289), titled “Programmable Time Division Multiplexed Switching,” the entire contents of each of which are hereby incorporated herein by reference in its entirety. Because the service and power control orchestrator 200 is deployed on a ROADM, as used herein, the network element 214 is implemented as a ROADM unless specifically stated otherwise.

FIG. 13A illustrates an example of the third network element 214c being a ROADM that interconnects the first fiber optical link 222a, the second fiber optical link 222b, and the third fiber optic link 222c. Each of the first fiber optic link 222a, the second fiber optic link 222b, and the third fiber optic link 222c may include optical fiber pairs, wherein each fiber of the pair carries optical signal groups propagating in opposite directions. As seen in FIG. 13A, for example, the first fiber optical link 222a includes a first optical fiber 222a-1, which carries optical signals toward third network element 214c and a second optical fiber 222a-2 that carries optical signals out from the third network element 214c. Similarly, the second fiber optic link 222b may include fiber optical links 222b-1 and 222b-2 carrying optical signal groups to and from the third network element 214c, respectively. Further, the third fiber optic link 222c may include first fiber optic link 222b-1 and second fiber optic link 222b-2 also carrying optical signals to and from the third network element 214c, respectively. Additional nodes, not shown in FIG. 13A, may be provided that supply optical signal groups to and receive optical signal groups from the third network element 214c. Such nodes may also have a ROADM having the same or similar structure as that of the third network element 214c.

As further shown in FIG. 13A, a light sink 300 (described below in more detail and shown in FIG. 13B) and a light source 304 (described below in more detail and shown in FIG. 13C) may be provided and in communication with the third network element 214c to drop and add optical signal groups, respectively.

As shown in FIG. 13A, the third network element 214c may include a plurality of wavelength selective switches (WSS module 308), such as first, second, third, fourth, fifth, and sixth WSSs 308a-f. Wavelength selective switches are components that can dynamically route, block and/or attenuate received optical signal groups input from and output to optical fiber links 222a-n as well as activate the passband 110 as discussed above using the launch protocol. In addition to transmitting/receiving optical signal groups from network elements 214, optical signal groups may also be input from or output to the light source 304 and light sink 300, respectively.

In one embodiment, each WSS module 308 may include a reconfigurable, optical filter operable to allow a passband (e.g., particular bandwidth of the spectrum of the optical signal) to pass through or be routed as herein described.

As further shown in FIG. 13A, each WSS 308a-f can receive optical signal groups (e.g., optical passbands) and may be operable to selectively switch, or direct, such optical signal groups to other WSSs for output from the third network element 214c. For example, the first WSS 308a may receive optical signal groups on a first optical fiber 222a-1 and supply certain optical signal groups to the sixth WSS 308f, while others are supplied to a fourth WSS 308d. Those supplied to the sixth WSS 308f may be output to a downstream network element 214, such as the second network element 214b (FIG. 11) on a fourth optical fiber 222b-2, while those supplied to the fourth WSS 308d may be output to the fourth network element 214d on a sixth optical fiber 222c-2. Also, optical signal groups input to the third network element 214c on a third fiber optic link 222b-1 may be supplied by the fifth WSS 308e to either the second WSS 308b and on to the first network element 214a via the second optical fiber 222a-2 or the fourth WSS 308d and on to the fourth network element 214d via the sixth optical fiber 222c-2. Moreover, the third WSS 308c may selectively direct optical signal groups (e.g., selectively switch optical passband groups) input to the third network element 214c from the fifth optical fiber 222c-1 to either the second WSS 308b and onto the first network element 214a via the second optical fiber 222a-2 or to the sixth WSS 308f and onto the second network element 214b via the fourth optical fiber 222b-2.

The first WSS 308a, third WSS 308c, and fifth WSS 308e may also selectively or controllably supply optical signal groups to the light sink 300 and optical signal groups may be selectively output from the light source 304 in the third network element 214c. The optical signal groups output from the light source 304 may be selectively supplied to one or more of the second WSS 308b, fourth WSS 308d, and sixth WSS 308f, for output on to the second optical fiber 222a-2, fourth optical fiber 222b-2, and sixth optical fiber 222c-2, respectively.

In one implementation, the third network element 214c may further comprise a node processor 290 and a non-transitory computer readable medium referred to herein as node memory 294 storing at least some of the software control blocks 10 including, but not limited to the multiplexer control block 12 which is executed by the node processor 290. The node processor 290 may include, but is not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The node processor 290 is in communication with the node memory 294 and may be operable to read and/or write to the node memory 294. The node processor 290 may be capable of communicating with one or more of the WSS module 308 (shown as in communication with the third WSS 308c and the first WSS 308a for simplicity, however, the node processor 290 may be in communication with each WSS module 308). The node processor 290 may be further capable of interfacing and/or communicating with the network elements 214 via the communication network 234. For example, the node processor 290 may be capable of communicating via the communication network 234 by exchanging signals (e.g., analog, digital, optical, and/or the like) via one or more ports (e.g., physical or virtual ports) using a network protocol to provide information to the one or more network element 214.

In one implementation, the node memory 294 of the network element 214, such as of the third network element 214c, may store a software application 296, such as the software control blocks 10, including but not limited to the multiplexer control block 12, the upstream optical control domain 14, the downstream optical control domain 16, and the user domain 18 that, when executed by the node processor 290, causes the node processor 290 to perform an action, for example, communicate with or control one or more component of the network element 214 such as control one or more of the WSS module 308.

In one implementation, the node memory 294 may store one or more of the datastore 298. The datastore 298 may include, for example, structured data from relational databases, semi-structured data, unstructured data, time-series data, binary data, and the like and/or some combination thereof. The datastore 298 may be a data base, a remote accessible storage, or a distributed filesystem. In some embodiments, the datastore 298 may be a component of an enterprise network. The datastore 298 may implement the upstream data store 62, the secondary control data store 64, the primary control data store 66, the downstream data store 70, and the monitoring data store 88.

Referring now to FIG. 13B, shown therein is a diagram of an exemplary implementation of the light source 304 of FIG. 13A constructed in accordance with the present disclosure. The light source 304 may comprise one or more transmitter processor circuit 320, one or more laser 324, one or more modulator 328, one or more semiconductor optical amplifier 332, and/or other components (not shown).

The transmitter processor circuit 320 may have a Transmitter Forward Error Correction (FEC) circuitry 336, a Symbol Map circuitry 340, a transmitter perturbative pre-compensation circuitry 344, one or more transmitter digital signal processor (DSP) 348, and one or more digital-to-analogue converters (DAC) 352. The transmitter processor circuit 320 may be located in any one or more components of the light source 304, or separate from the components, and/or in any location(s) among the components. The transmitter processor circuit 320 may be in the form of one or more Application Specific Integrated Circuit (ASIC), which may contain one or more module and/or custom module.

Processed electrical outputs from the transmitter processor circuit 320 may be supplied to the modulator 328 for encoding data into optical signals generated and supplied to the modulator 328 from the laser 324. The semiconductor optical amplifier 332 receives, amplifies, and transmits the optical signal including encoded data in the spectrum. Processed electrical outputs from the transmitter processor circuit 320 may be supplied to other circuitry in the transmitter processor circuit 320, for example, clock and data modification circuitry. The laser 324, modulator 328, and/or semiconductor optical amplifier 332 may be coupled with a tuning element (e.g., a heater) (not shown) that can be used to tune the wavelength of an optical signal channel output by the laser 324, modulator 328, or semiconductor optical amplifier 332. In some implementations, a single one of the laser 324 may be shared by multiple light source 304.

Other possible components in the light source 304 may include filters, circuit blocks, memory, such as non-transitory memory storing processor executable instructions, additional modulators, splitters, couplers, multiplexers, etc., as is well known in the art. The components may be combined, used, or not used, in multiple combinations or orders. Optical transmitters are further described in U.S. Patent Publication No. 2012/0082453, the content of which is hereby incorporated by reference in its entirety herein.

Referring now to FIG. 13C, shown therein is a block diagram of an exemplary implementation of the light sink 300 constructed in accordance with the present disclosure. The light sink 300 may comprise one or more local oscillator 374, a polarization and phase diversity hybrid circuit 375 receiving the one or more channel from the optical signal and the input from the local oscillator 374, one or more balanced photodiode 376 that produces electrical signals representative of the one or more channel on the spectrum, and one or more receiver processor circuit 377. Other possible components in the light sink 300 may include filters, circuit blocks, memory, such as non-transitory processor-readable memory storing processor-executable instructions, additional modulators, splitters, couplers, multiplexers, etc., as is well known in the art. The components may be combined, used, or not used, in multiple combinations or orders. The light sink 300 may be implemented in other ways, as is well known in the art. Exemplary implementations of the light sink 300 are further described in U.S. patent application Ser. No. 12/052,541, titled “Coherent Optical Receiver”, the entire contents of which are hereby incorporated by reference.

The one or more receiver processor circuit 377, may comprise one or more analog-to-digital converter (ADC) 378 receiving the electrical signals from the balanced photodiodes 376, one or more receiver digital signal processor (hereinafter, receiver DSP 379), receiver perturbative post-compensation circuitry 380, and receiver forward error correction circuitry (hereinafter, receiver FEC circuitry 381). The receiver FEC circuitry 381 may apply corrections to the data, as is well known in the art. The one or more receiver processor circuit 377 and/or the one or more receiver DSP 379 may be located on one or more component of the light sink 300 or separately from the components, and/or in any location(s) among the components. The receiver processor circuit 377 may be in the form of an Application Specific Integrated Circuit (ASIC), which may contain one or more module and/or custom module. In one embodiment, the receiver DSP 379 may include, or be in communication with, one or more processor 382 and one or more memory 383 storing processor readable instructions, such as software, or may be in communication with the node processor 290 and the node memory 294.

The one or more receiver DSP 379 may receive and process the electrical signals with multi-input-multiple-output (MIMO) circuitry, as described, for example, in U.S. Pat. No. 8,014,686, titled “Polarization demultiplexing optical receiver using polarization oversampling and electronic polarization tracking”, the entire contents of which are hereby incorporated by reference herein. Processed electrical outputs from receiver DSP 379 may be supplied to other circuitry in the receiver processor circuit 377, such as the receiver perturbative post-compensation circuitry 380 and the receiver FEC circuitry 381.

Various components of the light sink 300 may be provided or integrated, in one example, on a common substrate. Further integration is achieved by incorporating various optical demultiplexer designs that are relatively compact and conserve space on the surface of the substrate.

In use, the one or more channel of the spectrum may be subjected to optical nonlinear effects between the light source 304 and the light sink 300 such that the spectrum received does not accurately convey carried data in the form that the spectrum was transmitted. The impact of optical nonlinear effects can be partially mitigated by applying perturbative distortion algorithms using one or more of the transmitter perturbative pre-compensation circuitry 371 and the receiver perturbative post-compensation circuitry 380. The amount of perturbation may be calculated using coefficients in algorithms and known or recovered transmitted data. The coefficients may be calculated, in accordance with U.S. Pat. No. 9,154,258 entitled “Subsea Optical Communication System Dual Polarization Idler”, herein incorporated by reference in its entirety, by use of analysis of one or more incoming channel at the light sink 300.

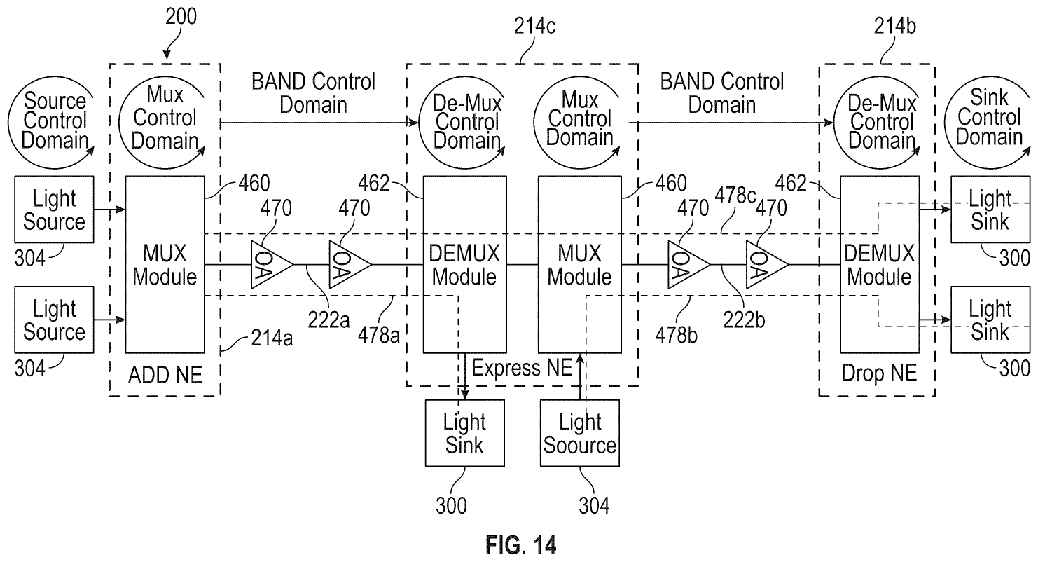

Referring now to FIG. 13D, shown therein is a diagram of the WSS module 308 (i.e., any of the WSS modules 308a-f) shown in FIG. 13A. The WSS module 308 may comprise a WSS 452 comprising a plurality of tributary ports 454 and a line port 456. Although three tributary ports 454 and one line port 456 are shown in FIG. 13D, persons having ordinary skill in the art will understand that the WSS 452 may have other numbers of tributary ports 454 and line ports 456. The WSS module 308 may be operable to receive a plurality of passbands at the tributary ports 454 of the WSS 452, multiplex the passbands, and transmit the passbands at the line port 456 of the WSS 452. The WSS module 308 in this configuration (i.e., where the tributary ports 454 are inputs and the line port 456 is an output) may be referred to as a multiplexer (MUX) module 460 as shown in FIG. 14. The WSS module 308 also may be operable to receive a plurality of passbands at the line port 456 of the WSS 452, de-multiplex the passbands, and transmit the passbands at the tributary ports 454 of the WSS 452. The WSS module 308 in this configuration (i.e., where the line port 456 is an input and the tributary ports 454 are outputs) may be referred to as a de-multiplexer (DEMUX) module 462 as shown in FIG. 14. In some embodiments, each of the WSS modules 308 is further operable to apply variable attenuation for each of the passbands so that power levels may be changed at the outgoing port (i.e., the line port 456 for the MUX modules and the tributary ports 454 for the DEMUX modules) for the passbands, such as the sub-passbands 116 and 154, or the primary sub-passband 150.

In some embodiments, each of the WSS modules 308 also may be operable to control the attenuation for each of the passbands. Such variable power adjustable functionality may be advantageous to permit flexibility in adapting to changes in the optical characteristics of the optical transport network 200 (e.g., loss in fiber, equipment aging, optical interference, configuration changes, etc.). Generally, each of the MUX modules and DEMUX modules comprise the same type of optical element (e.g., the WSS 452). However, persons having ordinary skill in the art will understand that the MUX modules and the DEMUX modules may comprise different types of optical elements. The multiplexing and de-multiplexing functionality of the WSSs 452 may be implemented using a variety of technologies, such as LCoS, MEMS arrays, etc.

Each of the WSS modules 308 may further comprise a processor 469 and a non-transitory memory 474 storing the software control blocks 10 and the data stores 62, 64, 66, 70, and 88. Each of the MUX modules may optionally comprise an Optical Amplifier which may be used to boost the power of the optical signal as it is ejected from the outgoing port of the MUX module (i.e., the line port 456 of the WSS 452). Each of the DEMUX modules may optionally comprise an optical amplifier which may be used to boost the power of the optical signal which is received at the input port of the DEMUX module (i.e., the line port 456 of the WSS 452).

Referring now to FIG. 14, shown therein is another diagram of the optical transport network 200 shown in FIG. 11. FIG. 14 illustrates the concept of optical dependency between optical services as defined herein. Optical services are said to be “optically dependent” if the optical services share a common fiber optic link 222. If two optical services are optically dependent and belong to different bands, then a power variation applied to one of the optical services may cause power transients to be experienced by the other optical service due to the SRS effect discussed above. Similarly, fiber optic links 222a-n are said to be optically dependent if the fiber optic links 222a-n share at least one optical service between them that is activated on each of the fiber optic links 222a-n. If the at least one optical service is shared between the fiber optic links 222a-n, but is only activated on one fiber optic link 222, then the two fiber optic links 222a-n are not said to be optically dependent.

FIG. 14 illustrates a first optical service 478a being added by the first ROADM 214a, transported on the first fiber optic link 222a, and dropped by the intermediary ROADM 214c; a second optical service 478b being added by the intermediary ROADM 214c, transported on a second fiber optic link 222b, and dropped by the second ROADM 214b; and a third optical service 478c being added by the first ROADM 214a, transported on the first fiber optic link 222a and the second fiber optic link 222b, and dropped by the second ROADM 214b. In this configuration, the first optical service 478a and the third optical service 478c are optically dependent, and the second optical service 478b and the third optical service 478c are optically dependent, but the first optical service 478a and the second optical service 478b are not optically dependent, because they are not transported on the same fiber optic link 222 at any point. Further, the first fiber optic link 222a and the second fiber optic link 222b would be optically dependent if the third optical service 478c were activated on both of the first fiber optic link 222a and the second fiber optic link 222b, but the first fiber optic link 222a and the second fiber optic link 222b would not be optically dependent if the third optical service 478c were not activated on both of the first fiber optic link 222a and the second fiber optic link 222b.

As shown in FIG. 14, the optical transport network 200 comprises multiple optical elements—the light sources 304 which convert the digital data into optical wavelengths, the light sinks 300 which convert the optical wavelengths back into the digital data, the network elements 214a, 214b, and 214c including mux modules 460 which multiplexes optical wavelengths from multiple light sources 304, a de-mux module 462 which de-multiplexes optical wavelengths to multiple light sinks 300 and optical amplifiers 470 which amplify the whole of the C/L/C+L band.

Each of the optical elements i.e. —WSS module 308 and optical amplifiers 470 used in the optical transport network 200 have some target power which needs to be launched on the outgoing fiber which is optimal enough so that the receiving equipment on the other end of the fiber 22 has the best quality of signal received. The aim of launching with such optimal powers is to have good signal-to-noise-ratio (SNR) values so that the signal quality can be maintained over the longest distance possible in the optical transport network 200 and hence achieve cost optimization.

Hence, each of the optical elements have an associated optical power control loop running which periodically monitors the power levels and automatically adjusts the attenuation levels/gain associated with the optical element so as to maintain the optimal launched power anytime. The optical amplifiers 470 may contain VOAs through which the power levels can be controlled. It may be possible that the amplifier gain itself might be adjustable by the optical power control loop. The optical power control loop associated with an optical amplifier does the targeting at the band level. The WSS module 308 used in the mux/de-mux module 460/462 which apart from the multiplexing or demultiplexing the passbands from/to the respective tributary ports also has attenuation control knobs through which its associated optical power control loop can change the power level of the passband. The targeting at mux/de-mux module 460/462 is on a per passband basis. There may be VOAs used in mux/de-mux modules 460/462 as well depending on design of the module. Such variable power adjustable components are required to have flexibility of adapting to the changes in the optical characteristics of the optical transport network 200 for example—loss in fiber, equipment ageing, optical interference, configuration changes, etc.

In the scope of this disclosure, an optical power control loop managing a particular optical element(s) has been termed as a control domain which manages the optical power controls related aspects and configurations associated with the network element 214. Five types of control domains are described below:
1. Mux WSS control domain: The Mux WSS control domain manages the mux WSS passband configurations and attenuation adjustments. The granularity of the optical controls is at a passband level.
2. De-mux WSS control domain: This De-Mux WSS control domain manages the de-mux WSS passband configurations and attenuation adjustments. The granularity of the optical controls is at a passband level.
3. Link control block: The link control domain manages the configurations and attenuation and(or) gain adjustments for all the amplifiers/VOAs in a transmission link between two ROADMs. The granularity of the optical controls is at a band level (e.g., C/L/C+L).
4. Source control domain: The source control domain manages the configurations, power levels and attenuations for the light sources 304.
5. Sink control domain: The sink control domain manages the configurations, attenuations and other aspects for the light sinks 300.

In the optical transport network 200 as described above a notion of control domains is provided from the add network element 214a to the drop network element (NE) 214b. Within a domain there are many control elements, the adjustments would be done through some protocol keeping synchronization and other factors into account. For example, as can be seen in the FIG. 14, the various control domains have been shown, mainly the Source control domain, Mux control domain/De-mux control domain (or generalized WSS controller domain), Band control domain and Sink control domain. Between each domain there is a flow of control information which consists of optical parameters such as measured power levels, active number of wavelengths, noise levels, slice counts, etc. The flow of control information can happen on a periodic basis and even on a demand basis from the downstream domain requesting the upstream domain to provide the latest control data. The flow of control information can be either via an in-band or out-of-band overhead communication channel for example the Optical Supervisory Channel or even can happen via a means of an external network element controller co-coordinating between the various network elements 214 and control domains.

FIG. 14 shows a unidirectional traffic view along with the various control domains starting from the add network element 214a passing through an express network element 214c to the drop network element 214b.

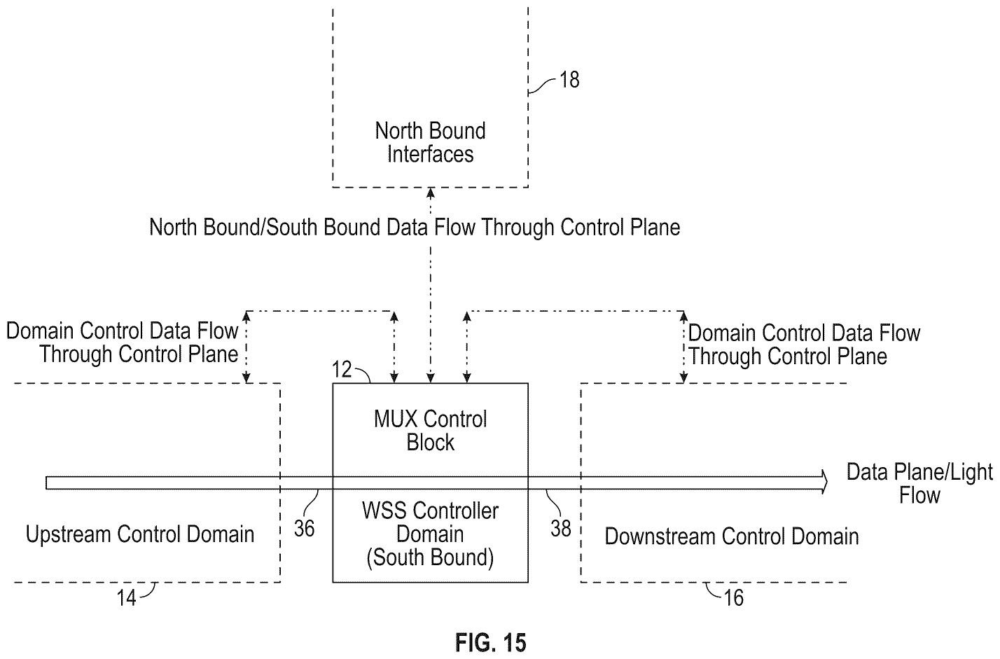

FIG. 15 is a block diagram illustrating a flow of information around the multiplexer control block 12, including the upstream optical controls domain 14, the downstream optical controls domain 16, and the user domain 18. The information flow generally involves a passband provisioning information from the user domain 18 to the multiplexer control block 12, passband control information from the upstream optical control domain 14 to the multiplexer control block 12 and from the multiplexer control block 12 to the downstream optical control domain 16, alarms and performance monitoring information from the multiplexer control block 12 to the performance monitoring application 84, synchronization specific messages, etc. For the case of the multiplexer control block 12, the upstream optical control domain 14 is the source control domain on an add network element 214a or Demux WSS controller domain on an express network element 214c, the downstream control domain is the band control domain. For the case of the Demux WSS controller domain, the upstream control domain is the band control domain and the downstream control domain is Mux WSS controller domain on the express network element 214c or the sink control domain on the drop network element 214b.

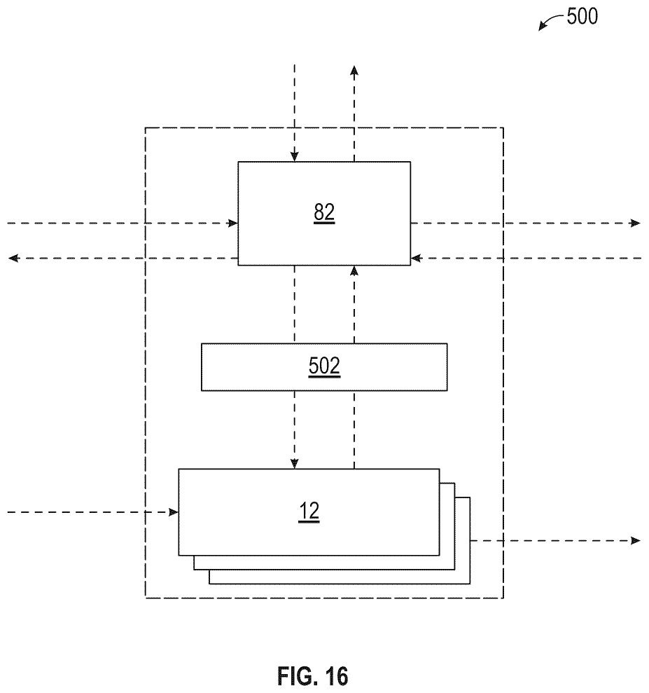

Referring to FIG. 16, shown there is a sub-system 500 implemented on a ROADM and comprises the supervisory power control orchestrator 82, a power control agent 502 and one or more multiplexer control block 12. The one or more multiplexer control block 12 may be operable to control one or more component of the network element 214 via an optical power control-related configuration of the optical transport network 200 (i.e., by adjusting one or more attenuation level and/or one or more gain associated with the network element 214) such that a target optical power level in the fiber optic link 222 is maintained within a tolerance level of optimal levels all of the time. Maintaining such a target optical power level may have the effect of guaranteeing that receiving equipment (i.e., a light sink 300 of a receiving network element 214) receives a higher-quality signal with a good Signal-to-Noise Ratio (SNR) and with minimal distortion. Further details regarding how to make and use the service and power control orchestrator 82 can be found in the United States patent application identified by U.S. Ser. No. 18/163,636 and filed on Feb. 2, 2023, the entire content of which is hereby incorporated herein by reference.

From the above description, it is clear that the inventive concept(s) disclosed herein are well adapted to carry out the objects and to attain the advantages mentioned herein, as well as those inherent in the inventive concept(s) disclosed herein. While the implementation s of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A network element, comprising:
a processor;
a first line port optically coupled to a first optical fiber link carrying a first optical signal having a first plurality of passbands;
a wavelength selective switch in optical communication with the first line port, the wavelength selective switch being operable to selectively switch the first optical signal into a second optical signal having a second plurality of passbands;
a second line port optically coupled to a second optical fiber link and operable to carry the second optical signal having the second plurality of passbands, the second line port in optical communication with the wavelength selective switch;
an optical power monitor coupled to at least one of the first optical link and the second optical link, and operable to measure optical power within at least one of the first plurality of passbands and the second plurality of passbands; and
a memory comprising a non-transitory processor-readable medium storing an upstream data adapter application, an optical power controller application, a control data re-allocator application, a monitoring and downstream data distributor application and storing processor-executable instructions that when executed by circuitry cause the circuitry to:
store, in a first database, by the upstream data adapter application, a start frequency and an end frequency of a passband to be activated in the second plurality of passbands;
create, by the upstream data adapter application, first data indicative of a first sub-passband within the passband and store the first data within a second database;
send signals, by the optical power controller application, to the wavelength selective switch to activate the first sub-passband in the second optical link using the first data and updating the first data with first parameters indicative of the activated first sub-passband, the first sub-passband being a primary activated sub-passband;
merge the first data into a third database;
create, by the upstream data adapter application, second data indicative of a second sub-passband within the passband and store the second data within the second database, the second sub-passband being contiguous with the first sub-passband;
enabling, by the optical power controller application, the wavelength selective switch to activate the second sub-passband in the second optical link using the second data and updating the second data with second parameters indicative of the activated second sub-passband;
merge, by the control data re-allocator application, the second data with the first data in the third database subsequent to the activation of the second sub-passband so as to expand the primary activated sub-passband with the activated second sub-passband; and
pass, by the monitoring and downstream data distributor application, at least a portion of the merged first data and the second data to another network element downstream on the second optical link.

2. The network element of claim 1 wherein the processor-executable instructions that when executed by the processor cause the processor to monitor power of the first sub-passband in the second optical link with the optical power monitor during the step of enabling activation of the second sub-passband in the second optical link.

3. The network element of claim 2 wherein the processor-executable instructions that when executed by the processor cause the processor to enable, by the optical power controller application, the wavelength selective switch to activate the second sub-passband in the second optical link using the second data and a power level of the first sub-band in the second optical link.

4. The network element of claim 2 wherein the processor-executable instructions that when executed by the processor cause the processor to enable, by the optical power controller application, the wavelength selective switch to maintain the power of the first sub-passband at a target power in the second optical link during enabling the wavelength selective switch to activate the second sub-passband in the second optical link.

5. The network element of claim 2 wherein the processor-executable instructions that when executed by the processor cause the processor to enable, by the optical power controller application, the wavelength selective switch to change the attenuation of the first sub-passband in the second optical link responsive to receiving a signal from the optical power monitor indicating a change in the power in the first sub-passband beyond a predetermined threshold.

6. The network element of claim 1, wherein the processor-executable instructions that when executed by the processor cause the processor to activate a carrier within the first sub-passband to carry data subsequent to the first sub-band being activated.

7. The network element of claim 1, wherein the processor-executable instructions that when executed by the processor cause the processor to activate a carrier spectrally spanning at least a portion of the first sub-passband and the second sub-passband subsequent to activation of the second sub-passband.

8. The network element of claim 1, wherein the processor-executable instructions that when executed by the processor cause the processor to signal a downstream network element receiving downstream activate a carrier spectrally spanning at least a portion of the first sub-passband and the second sub-passband subsequent to activation of the second sub-passband.

9. The network element of claim 1, wherein the processor-executable instructions that when executed by the processor cause the processor to merge the first data into the third database subsequent to activating the first sub-passband in the second optical link.

10. The network element of claim 1, wherein the processor-executable instructions that when executed by the processor cause the processor to split data describing the passband into the first data indicative of the first sub-passband within the passband and second data indicative of the second sub-passband within the passband with the upstream data adapter application.

11. The network element of claim 1, wherein the processor-executable instructions that when executed by the processor cause the processor to determine a presence of one or more active carriers within the second sub-passband, to determine whether the second sub-passband should be activated or closed.

12. The network element of claim 1, wherein the processor-executable instructions that when executed by the processor cause the processor to independently control power levels within the first sub-passband and the second sub-passband.

13. The network element of claim 1, wherein the processor-executable instructions that when executed by the processor cause the processor to perform performance monitoring actions on the first sub-passband and the second sub-passband.

14. A non-transitory computer readable medium storing computer executable instructions that when executed by a processor cause the processor to:
storing, in a database, a start frequency and an end frequency of a passband to be activated in an optical fiber link;
enabling a wavelength selective switch to activate a first sub-passband within the passband to carry data within the optical fiber link, the first sub-passband being contiguous with the start frequency or the end frequency of the passband and being spectrally between the start frequency and the end frequency;
enabling the wavelength selective switch to activate a second sub-passband within the optical fiber link during an activation period in which power levels of the second sub-passband are being gradually increased, the second sub-passband being contiguous with the first sub-passband and being spectrally between the provisioned start frequency and the provisioned end frequency; and
controlling power levels within the first sub-passband and the second sub-passband independently during the activation period.

15. The non-transitory computer readable medium of claim 14, wherein the computer executable instructions that when executed by a processor cause the processor to independently monitor a first stability of the first sub-passband and a second stability of the second sub-passband.

16. The non-transitory computer readable medium of claim 14, wherein the computer executable instructions that when executed by a processor cause the processor to add or delete a carrier within one of the first sub-passband and the second sub-passband to support resizable services without traffic disruption.

17. A non-transitory computer readable medium storing computer executable instructions that when executed by a processor cause the processor to:
storing, in a database, a start frequency and an end frequency of a passband to be deactivated in an optical fiber link;
enabling a wavelength selective switch to deactivate the passband in sub-passband increments; and
pass, by a monitoring and downstream data distributor application, the start frequency and the send frequency of the deactivated passband to another network element downstream on the optical fiber link.

18. The non-transitory computer readable medium storing computer executable instructions that when executed by a processor cause the processor to: control a first power level of a first sub-passband within the passband separately from a second power level of a second sub-passband within the passband.
